(19) United States
(12) Patent Application Publication
(10) Pub. No.: US 2006/0136806 A1
(43) Pub. Date: Jun. 22, 2006

(54) System and method for analysis of neurological condition

(75) Inventors: Brad J. Harris, San Jose, CA (US); Jennifer Smith, Menlo Park, CA (US); See-Chun Phan, Menlo Park, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Pharmacyclics, Inc., Sunnyvale, CA (US)

(21) Appl. No.: 11/313,535

(22) Filed: Dec. 20, 2005

Related U.S. Application Data
(60) Provisional application No. 60/638,798, filed on Dec. 22, 2004.

(51) Int. Cl. G06F 17/21

(52) U.S. Cl. 715/500

(57) ABSTRACT

Embodiments of the present invention comprise computer-based tools facilitating visualization and assessment of progression of neurological disorders in a patient. In one embodiment, data is received in the form of the results of standardized neurological examination of the patient. This input is compared to a rule set defining progression of the disorder, and the results of this comparison are displayed in an electronic document featuring internal links. The data may be displayed as tables and/or charts, with elapsed time plotted along a row/column or axis, respectively. Progression indication may be displayed through changed color. The electronic document can also display data not directly relevant to neurological condition, for example medication and radiation treatment schedules. By automatically displaying the data and the derived progression assessment according to the rule set, embodiments of the present invention are of particularly use in rapidly and uniformly evaluating treatment therapies.

### CROSS-REFERENCE TO RELATED APPLICATION

This Nonprovisional U.S. patent application claims priority to U.S. Provisional Patent Application No. 60/638,798, filed Dec. 22, 2004 and incorporated by reference herein for all purposes.

### BACKGROUND OF THE INVENTION

Prevention and/or palliation of neurological signs and symptoms due to illness are important goals of treatment. For example, for patients with metastatic tumors in the brain, improvement in survival may not necessarily be an appropriate goal of a local therapy that is intended to control tumor growth in the brain, because these patients have metastatic disease throughout the body, which often determines survival. Even for patients with primary brain tumors, treatments that favorably impact neurological outcomes would be beneficial. Neurological outcome assessments also may be useful in evaluating toxicity of brain tumor-directed therapies.

The evaluation of clinical benefit in patients with brain tumors or other neurological disorders is complex due to the diverse nature of clinical neurological signs and symptoms present in these patients. Tumor size, number, location, histology, systemic factors and prior therapies are some of the issues that complicate evaluation of patients having brain tumors. Medication regimens, use of corticosteroids, and other underlying systemic medical problems are further challenges to the assessment of treatment response.

Moreover, radiologic measurements, such as MRI and CT, used to assess tumor size and response, have not been found to necessarily correlate with, or predict, patient outcome or neurologic function. Assessment of tumor response and clinical benefit in patients with tumors involving the brain present many challenges for determination of the efficacy of new agents intended to treat brain tumors since frequently used endpoints such as response rate and time to tumor progression are problematic.

Ideally, analysis of neurologic complications should exhibit the following traits. First, the analysis should be based upon measurements unequivocally related to neurological conditions. The analysis should be based upon measurements conveniently accomplished in the setting of randomized multicenter trials. The analysis should be objective, unbiased, standardized, and easily validated. Finally, the analysis should consider relevant measures of clinical benefit, and allow documentation and auditing.

Accordingly, there is a need in the art for systems and methods allowing the objective assessment of the progression of neurological disorders.

### SUMMARY OF THE INVENTION

Embodiments of methods and systems in accordance with the present invention comprise computer-based tools facilitating visualization and assessment of the progression of a neurological disorder in an individual patient. In accordance with one embodiment, data is received in the form of the results of standardized neurological and neurocognitive examination of an individual patient. This input is compared to a predetermined rule set defining progression of the neurological disorder, and the results of this comparison are displayed in an electronic document featuring internal links between pages. The data may be displayed on pages in the format of tables and/or charts, with elapsed time plotted along a row/column or axis, respectively. Indication of progression may be displayed through a changed color. The electronic document can also display received data that is not directly relevant to neurological condition, for example medication and radiation treatment schedules. By automatically displaying the data received and the progression assessment derived therefrom according to the rule set, embodiments in accordance with the present invention are particularly relevant to clinical trials, allowing rapid and uniform evaluation of the effect of treatment therapies.

An embodiment of a method in accordance with the present invention for displaying information regarding progression of a neurological disorder, comprises, receiving as an input to a processor, a first datum of a first type relevant to neurological state of a patient at a first time, and a second datum of the first type relevant to neurological state of the patient at a second time subsequent to the first time. The processor is caused to apply a rule set to the first datum and the second datum to provide an indication of progression of the neurological disorder, and the processor is caused to generate an electronic document including the indication.

An embodiment of an electronic document in accordance with the present invention for visualizing progression of a neurological disorder in an individual patient, comprises, a contents page including a first link to a table of neurological symptoms, and a table of neurological symptoms page including a second link to a graphical display, wherein a progression of the neurological disorder is indicated by a change in color between a first data entry into the table and a second data entry into the table. The document further comprises a graphical display page wherein the progression of the neurological disorder is indicated by the change in color between a first data point plotted on a chart and a second data point plotted on the chart.

An embodiment in accordance with the present invention comprises a computer readable storage medium having a computer-readable program embodied therein for directing operation of a host computer including an input/output system, and a processor, wherein the computer-readable program includes instructions for operating the host computer to process medical information according to the following: receiving a first datum of a first type relevant to neurological state of a patient at a first time; receiving a second datum of the first type relevant to neurological state of the patient at a second time subsequent to the first time; applying a rule set to the first datum and the second datum to provide an indication of progression the neurological disorder; and causing the processor to generate an electronic document including the indication.

These and other embodiments of the present invention are described in more detail in conjunction with the text below and attached figures.

### BRIEF DESCRIPTION OF THE DRAWINGS

FIG. 1 shows an initial screen displaying output of an embodiment of a system in accordance with the present invention for analyzing neurological data.

FIG. 2 shows a screen displaying output of an embodiment of a system in accordance with the present invention, in the form of a table indicating progression of major neurologic criteria.

FIGS. 2A-2C show screen displays of output of a system in accordance with the present invention, in the form of a combined graph and listing for one examination result of a major criteria.

FIG. 3 shows a screen displaying output of an embodiment of a system in accordance with the present invention, in the form of a table indicating progression of minor neurologic criteria.

FIGS. 3A-3ZB show screen displays of output of an embodiment of a system in accordance with the present invention in the form of a combined graph and listing for one examination result of a minor criteria.

FIG. 4 shows a screen displaying an index of daily living.

FIG. 5A shows a screen displaying output of an embodiment of a system in accordance with the present invention, in the form of a table of medication usage.

FIG. 5B shows a screen displaying output of an embodiment of a system in accordance with the present invention, in the form of a graph of medication usage.

FIG. 6A shows a screen displaying output of an embodiment of a system in accordance with the present invention, in the form of a table of medication usage.

FIG. 6B shows a screen displaying output of an embodiment of a system in accordance with the present invention, in the form of a graph of medication usage.

FIG. 7A shows a screen displaying output of an embodiment of a system in accordance with the present invention, in the form of a table of medication usage.

FIG. 7B shows a screen displaying output of an embodiment of a system in accordance with the present invention, in the form of a graph of medication usage.

FIG. 8A shows a screen displaying output of an embodiment of a system in accordance with the present invention, in the form of a table of medication usage.

FIG. 8B shows a screen displaying output of an embodiment of a system in accordance with the present invention, in the form of a graph of medication usage.

FIG. 9 shows a display screen indicating cancer surgery and biopsy information in a tabular format.

FIG. 10 shows a display screen indicating radiation therapy information in a tabular format.

FIGS. 11A-N show screen displays of output of an embodiment of a system in accordance with the present invention, in the form of a combined graph and listing for one other sign of progression of a neurological disorder.

FIG. 12 shows a screen display of output of an embodiment of a system in accordance with the present invention, in the form of a table listing other symptoms of a neurological disorder.

FIG. 13 shows a screen display of output of an embodiment of a system in accordance with the present invention, in the form of a table listing other clinically significant abnormalities.

FIG. 14 shows a screen display of output of an embodiment of a system in accordance with the present invention, in the form of a table indicating decreased consciousness level.

FIG. 15 shows a screen display of output of an embodiment of a system in accordance with the present invention, in the form of a table indicating missed visits.

FIG. 16 shows a screen display of output of an embodiment of a system in accordance with the present invention, in the form of a table indicating missed neurocognitive testing.

FIG. 17 shows a screen displaying output of an embodiment of a system in accordance with the present invention, in the form of an array of graphs of different examination results.

FIG. 18 shows a simplified block diagram of the architecture of the software program for generating an electronic document in accordance with an embodiment of the present invention.

FIG. 19 is a simplified schematic view of the pages comprising an electronic document in accordance with an embodiment of the present invention.

FIG. 20 shows a simplified schematic view of one embodiment of a computer system in accordance with the present invention.

FIG. 20A is an illustration of basic subsystems in computer system of FIG. 20.

FIG. 21 is a simplified flow chart showing the steps undertaken to create the electronic document package.

### DESCRIPTION OF THE SPECIFIC EMBODIMENTS

Embodiments of methods and systems in accordance with the present invention comprise computer-based tools facilitating visualization and assessment of the progression of a neurological disorder in an individual patient. In accordance with one embodiment, data is received in the form of the results of standardized neurological and neurocognitive examination of an individual patient. This input is compared to a predetermined rule set defining progression of the neurological disorder, and the results of this comparison are displayed in an electronic document featuring internal links between pages. The data may be displayed on pages in the format of tables and/or charts, with elapsed time plotted along a row/column or axis, respectively. Indication of progression may be displayed through a color change. The electronic document can also display received data that is not directly relevant to neurological condition, for example medication and radiation treatment schedules. By automatically displaying the data received and the progression assessment derived therefrom according to the rule set, embodiments in accordance with the present invention are particularly relevant to clinical trials, allowing rapid and uniform evaluation of the effect of treatment therapies.

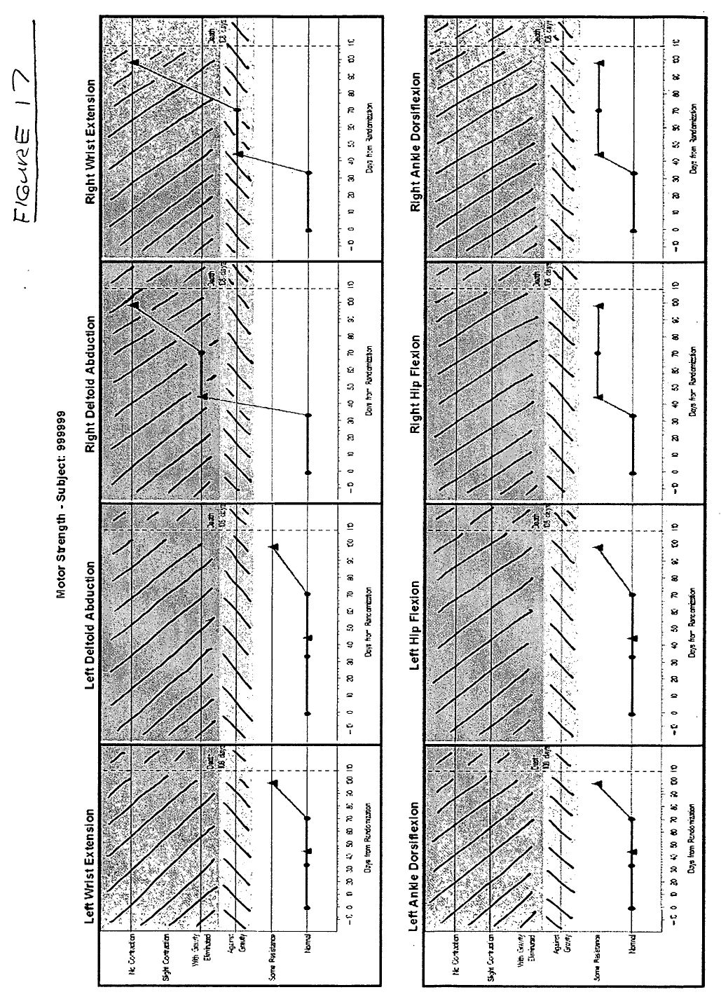

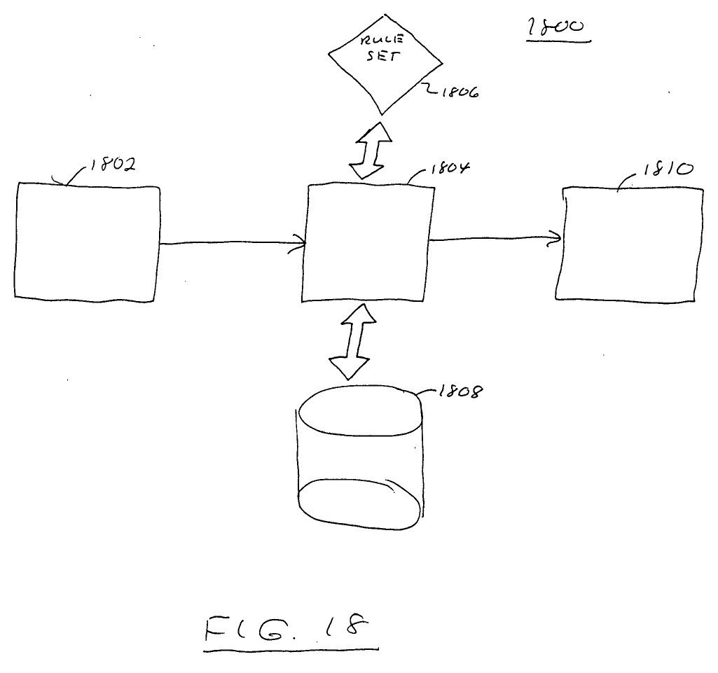

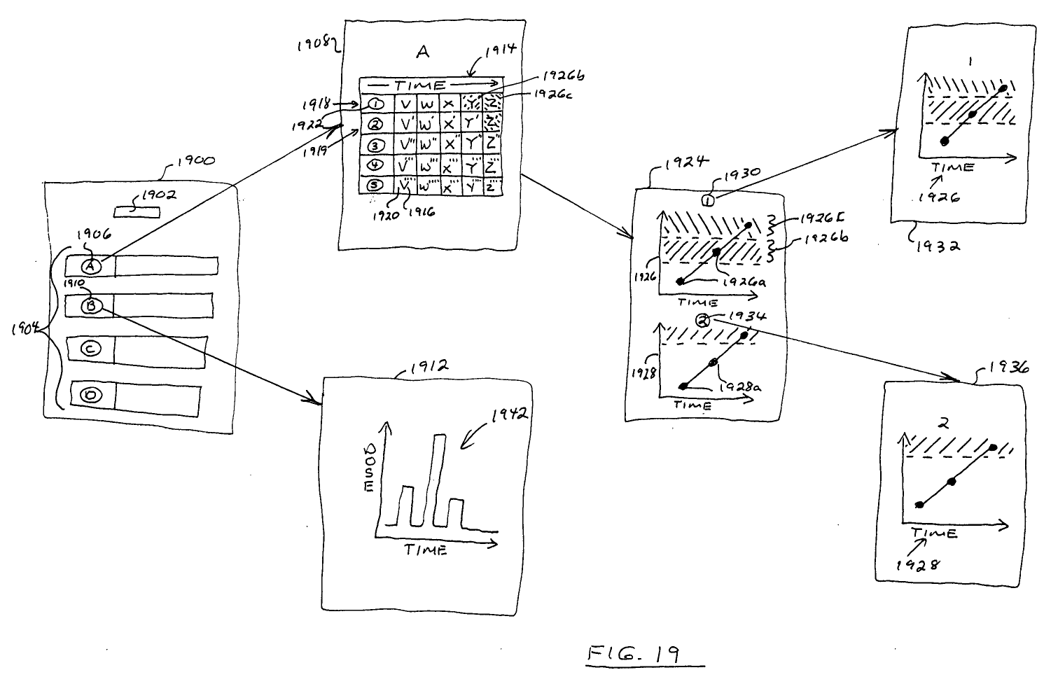

FIG. 19 shows a simplified generic view of the various display pages of an embodiment of an electronic document in accordance with the present invention. Initial page 1900 of the electronic document comprises a field 1902 identifying the particular individual patient, and a general listing 1904 of the contents of the electronic document. Contents listing 1904 includes first link 1906 to second page 1908, and second link 1910 to sixth page 1912.

Activation of first link 1906 results in the display of second page 1908 comprising table 1914 including data 1916 oriented in rows 1918 of fields 1920. The data displayed in table 1914 are results of examinations or tests known to be relevant to neurological state.

Fields 1920 may be colored as illustrated with hashing, in order to indicate a progression based upon comparison of the data with a predetermined rule set. Each row 1918 of table 1914 includes a header that is also a link 1922, identifying the specific examination or test for which data is provided in that row, for example a particular motor skill or neurocognitive test. Data in each row 1918 of table 1914 is presented according to increasing time.

Activation of link 1922 of the row header results in the display of a third page 1924 comprising an array of charts 1926 and 1928. Third page 1924 includes first chart 1926 plotting the data of row 1918 of table 1914 in chart format. First chart 1926 plots data points 1926a along the x-axis according to increasing time. Portions 1926b-c of first chart 1926 may be colored in the same manner as fields 1920 of table 1914, in order to indicate a progression of the neurological condition.

Third page 1924 also includes second chart 1928 plotting the data of row 1919 of table 1914 in chart format. Second chart 1928 also plots data points 1928a along the x-axis according to increasing time. Portions 1928b of second chart 1928 may also be colored to indicate a neurologic progression.

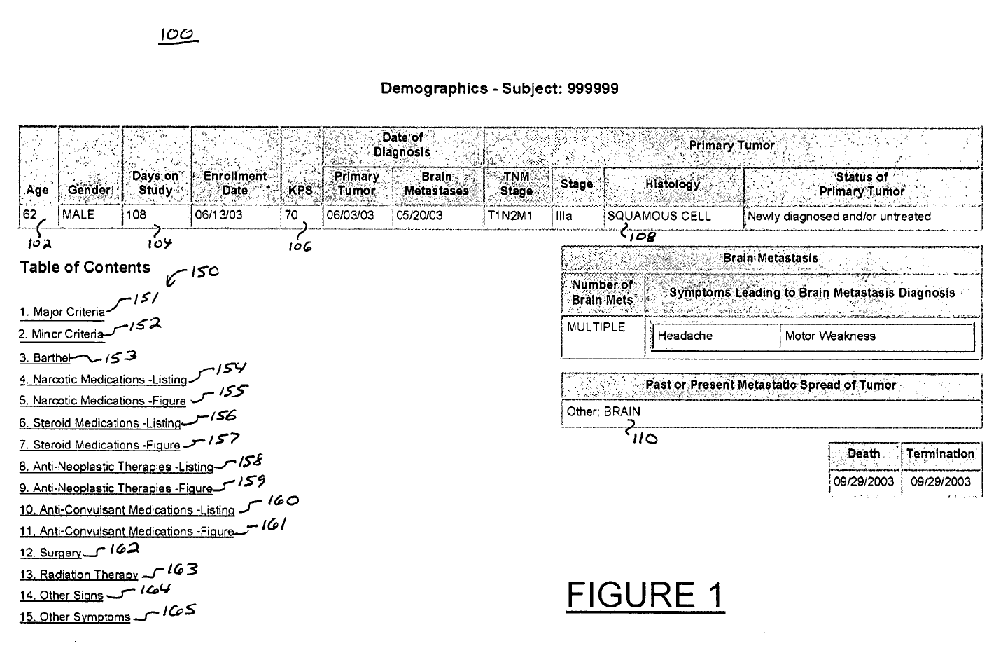

In the embodiment shown in FIG. 1, link 1922 of row 1918 of table 1914 of page 1980 also provides the user with information regarding the different examination or test result shown in row 1919. This is because the examination or test result of rows 1918 and 1919 are known to have some relation to one another, for example they may be common to a larger genus, for example tests or examination relating to a common physiological feature such as a nerve, whose results would be expected to correlate with one another.

This co-display of data from different types of patient examinations or tests can be eliminated by activation of link 1930 present on third page 1924, which then connects the user with a fourth page 1932 displaying only first chart 1926. Activation of link 1934 of third page 1924 would similarly connect the user with a fifth page 1936 displaying only second chart 1928.

FIG. 1 shows that contents listing 1904 of the initial page 1900 of the electronic document also includes link 1910. Activation of link 1910 results in the display of sixth page 1912 comprising a plot 1942 of information, with time as the x-axis. Data displayed on page 1940 is not necessarily relevant to the neurological state of a patient, for example a dosage administration schedule for a particular medication. However, a separate link 1910 to plot 1942 is provided to facilitate rapid access to this information, which may aid in proper interpretation of the neurologically-relevant information in reaching a conclusion regarding disease progression.

An embodiment of an electronic document in accordance with the present invention may be recorded and be accessible in a number of different formats. In one example, the electronic document may be encoded on a computer readable storage medium as a pdf file. Other possible formats include, but are not limited to jpg, tiff, giff, html, rtf, doc, and dhtml. Connection of different pages of the electronic document may be achieved through the use of bookmarks or other techniques.

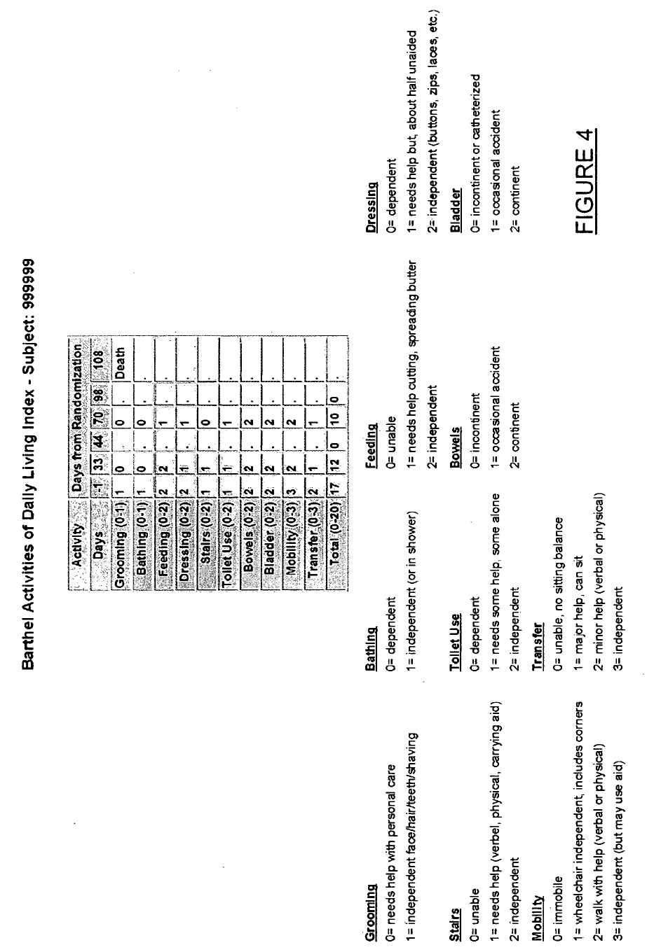

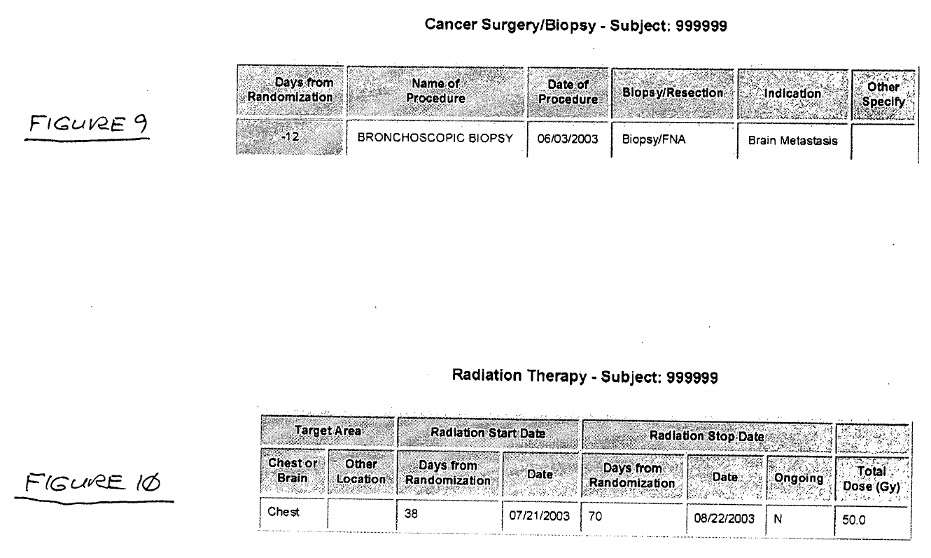

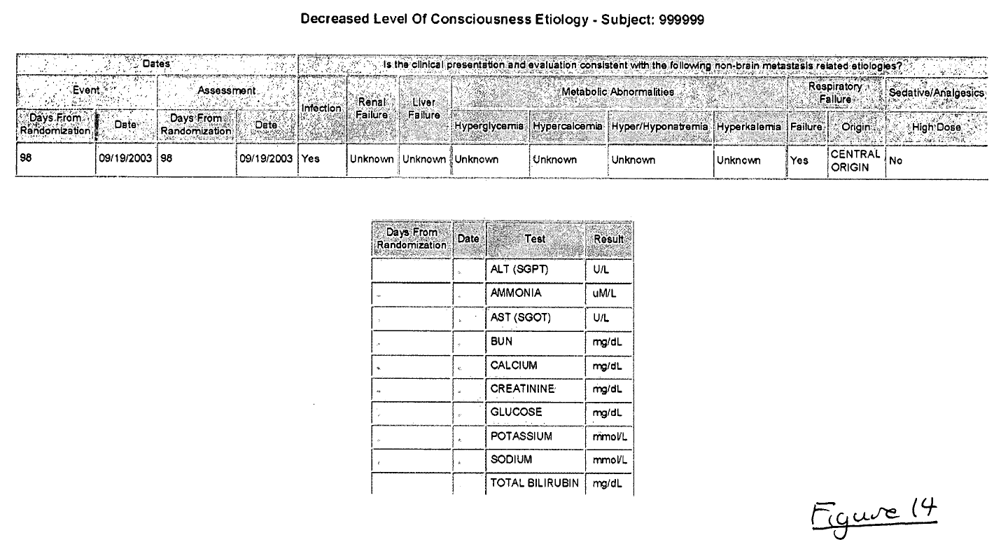

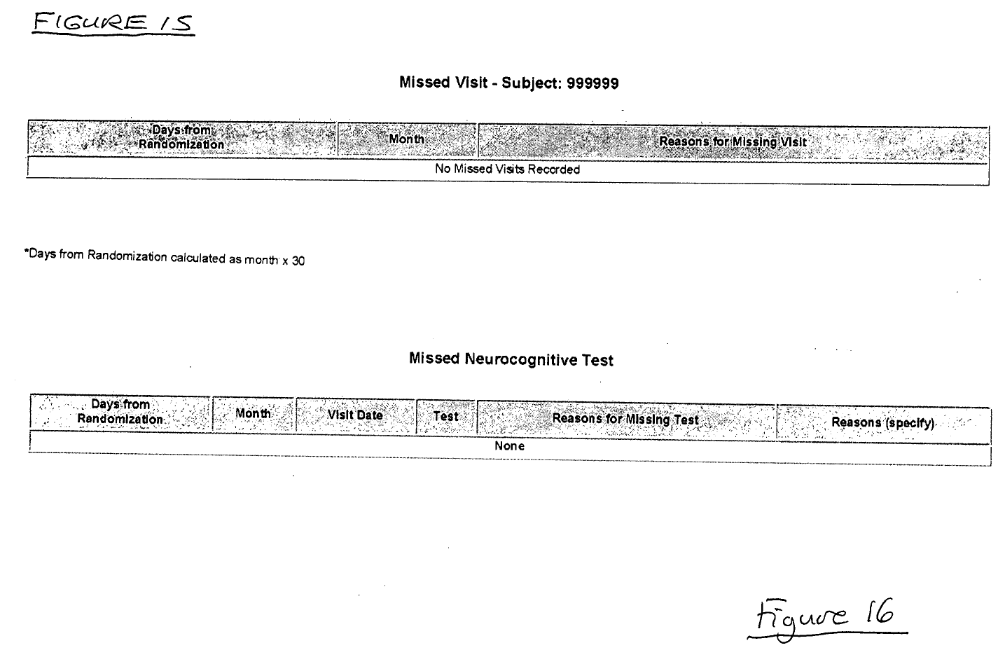

The following discussion of FIGS. 1-17 provides one specific embodiment of an electronic document in accordance with an embodiment of the instant invention, as applied to analyze the neurologic signs and symptoms associated with progression of tumors of the brain. However, this is merely one illustration of a particular embodiment, which is not limited to analysis of the progression this specific type of neurological condition.

In this specific example, the following major neurologic signs and symptoms have been determined to be reliable indicators of tumor progression in the brain, and have been selected for quantitative evaluation in accordance with embodiments of the present invention: altered mental status; aphasia; ataxia; paralysis; and visual field defects. Clinical findings related to these problems were elicited and recorded at baseline and at follow up visits, on case report forms. These data were presented in the form of graphic displays of embodiments in accordance with the present invention, as are illustrated in FIGS. 1-17 and discussed below. Deterioration from baseline in any one of these major criteria areas is considered progression of disease without the need for confirmation.

Another major criteria for neurologic progression is a significant change in neurocognitive function. (>2 standard deviations from baseline). Neurocognitive tests have been identified that are objective and quantitative, and not influenced by factors such as patient age, gender, mood, or prior therapies. These tests are interpreted and scored in a blinded manner, and provide formal, objective, and standardized measures of a patients' cognitive status.

In contrast to self-reported measures of functioning, neurocognitive tests reflect actual observed patient performance. Neurocognitive tests can be chosen to cover a broad range of abilities across multiple domains, and can therefore be individually sensitive to focal lesions, and together sensitive to variability in tumor location and generalized effects of tumor burden.

As described by Meyers et al., “Neurocognitive function and progression in patients with brain metastases treated with whole-brain radiation and motexafin gadolinium: results of a randomized phase III trial.” J of Clin Oncol 22:157-165, (2004), these neurocognitive tests have proven excellent predictors of patient outcome. In certain studies, these neurocognitive tests may reveal information about baseline neurological function that is the best predictor of patient survival. In the illustrated embodiment, the following specific neurocognitive tests were employed: the Hopkins Verbal Learning Tests (recall, recognition, delayed recall); and Controlled Oral Word Association Tests; and Trailmaking Test A and B.

In many cases, patients may experience neurologic problems that are more subjective and less quantitative. These neurologic problems may require more rigorous attempts to confirm their relationship to tumor progression. The following are examples of minor neurologic findings that are often present in brain tumor patients: sensory finding; seizures; change in orientation; mild motor weakness; facial weakness; pupil reflex deficits; dysarthria; oculomotor palsy; mild ataxia; and decline in neurocognitive test score.

In order to be scored as progression by embodiments in accordance with the present invention, patients with minor neurologic findings may be required to have multiple findings confirmed on consecutive visits separated by a period of time.

An electronic package in accordance with embodiments of the present invention prepared for each patient facilitates review of neurologic progression data. This electronic package comprises a bookmarked and internally linked document arranged to allow easy navigation to relevant information.

FIG. 1 shows the initial data display 100 and table of contents 150 that is displayed for the electronic package of a particular patient (no. 999999) who is suffering from a brain tumor. The data display 100 includes fields for baseline characteristics such as age 102, time on study 104, KPS 106, tumor histology 108, and metastatic spread 110.

The Table of Contents 150 permits review of the detailed clinical information in the most logical order by clicking on the relevant linked sections 151-165. First and second links 151 and 152 connect to tablular screen displays of major and minor neurologic progression criteria, respectively.

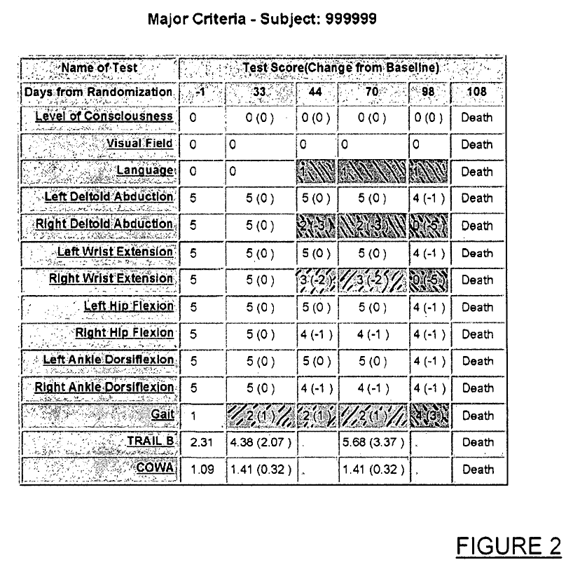

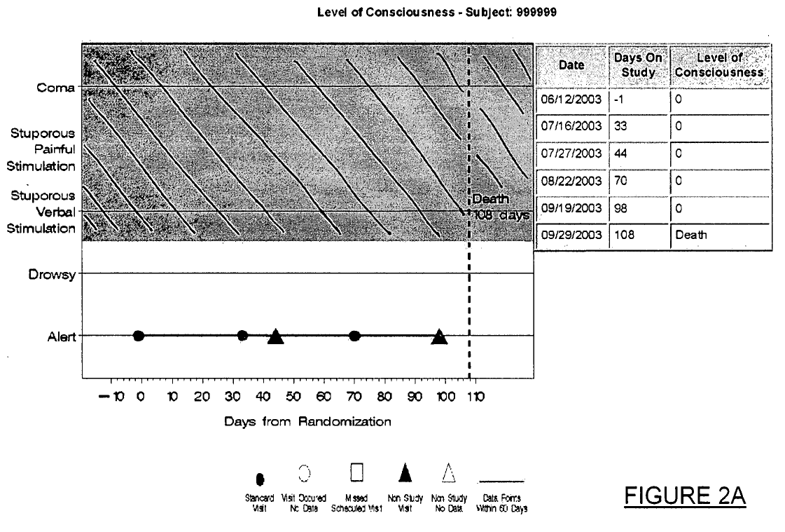

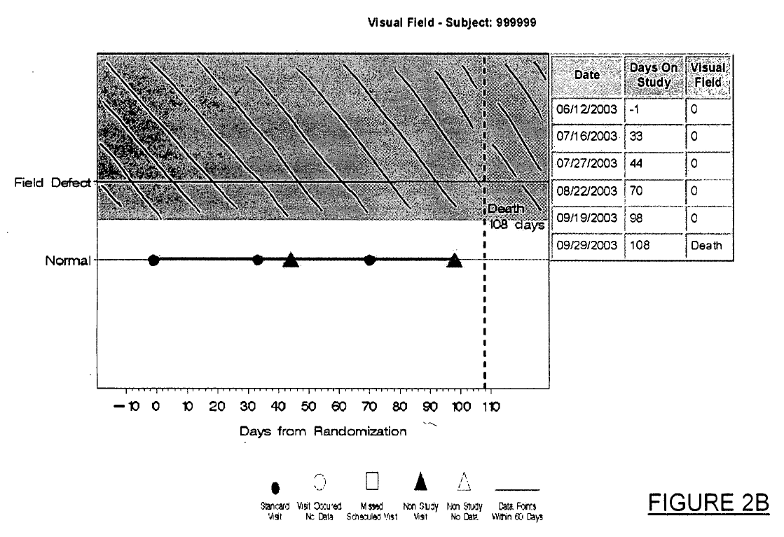

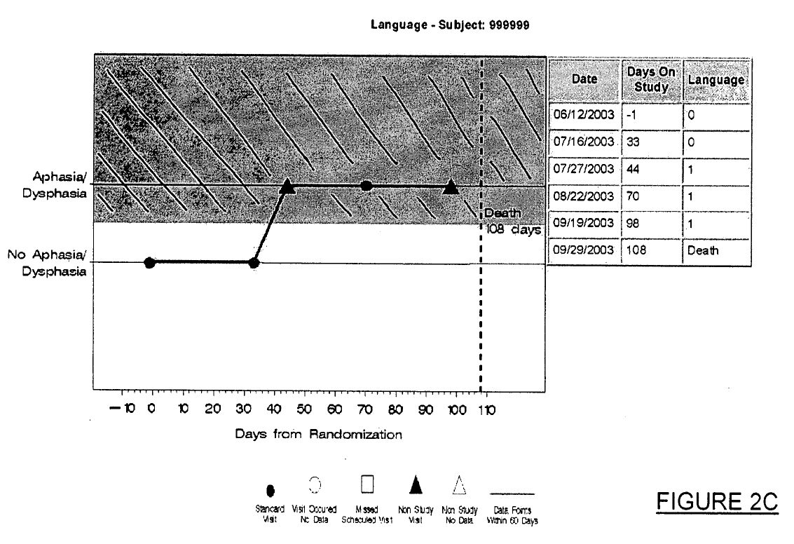

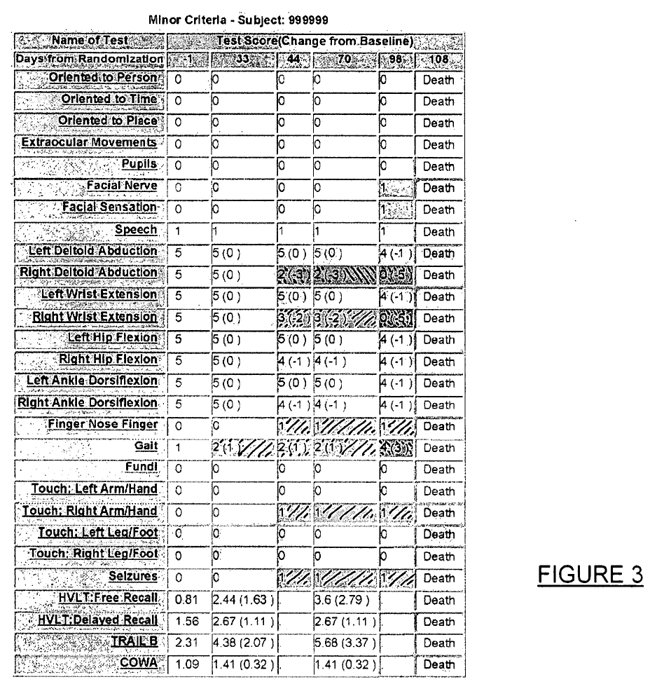

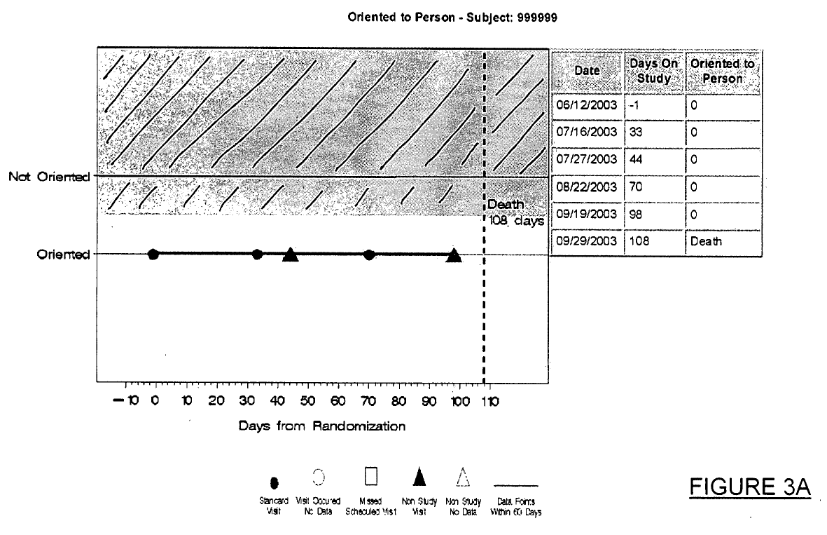

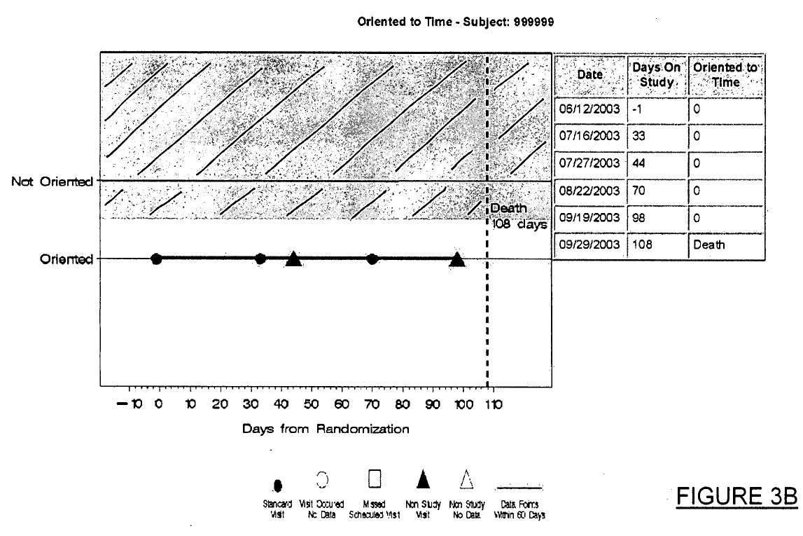

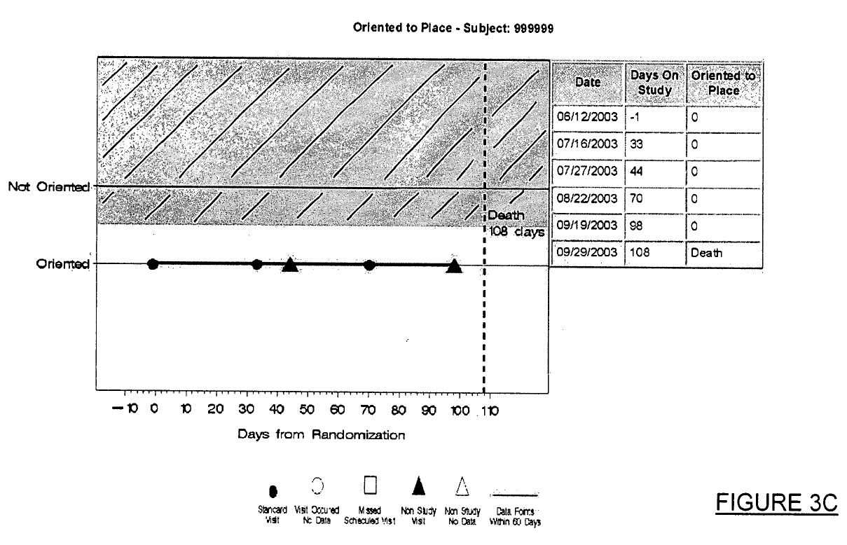

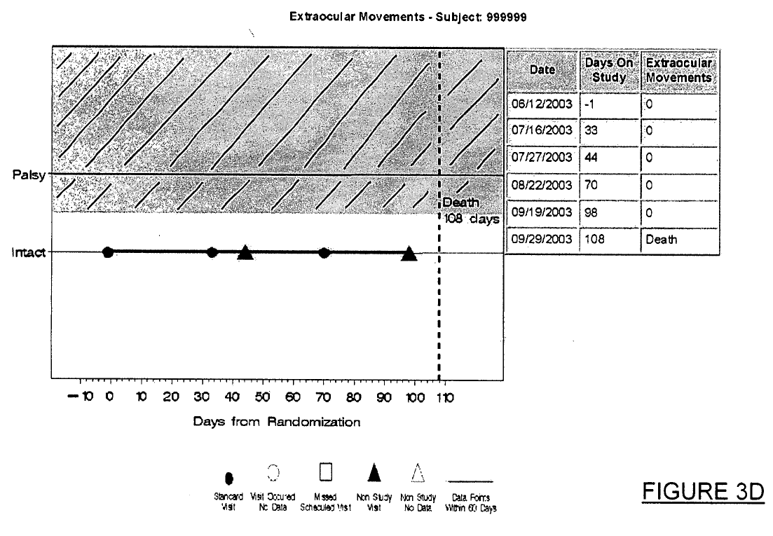

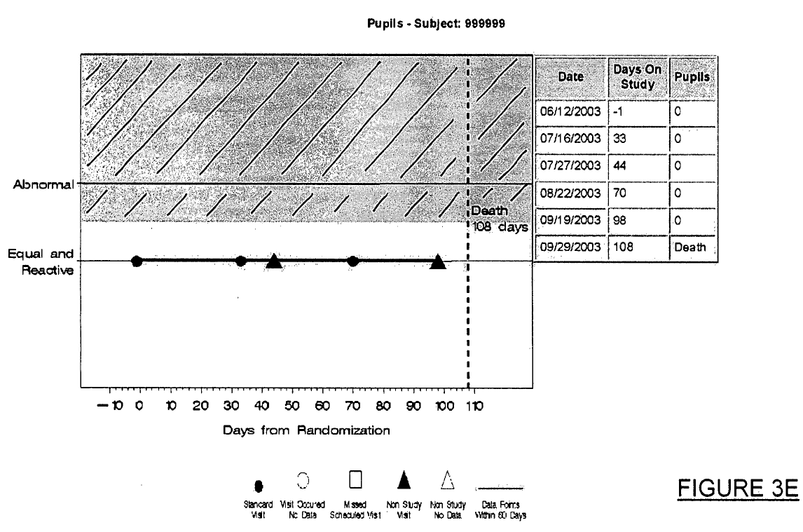

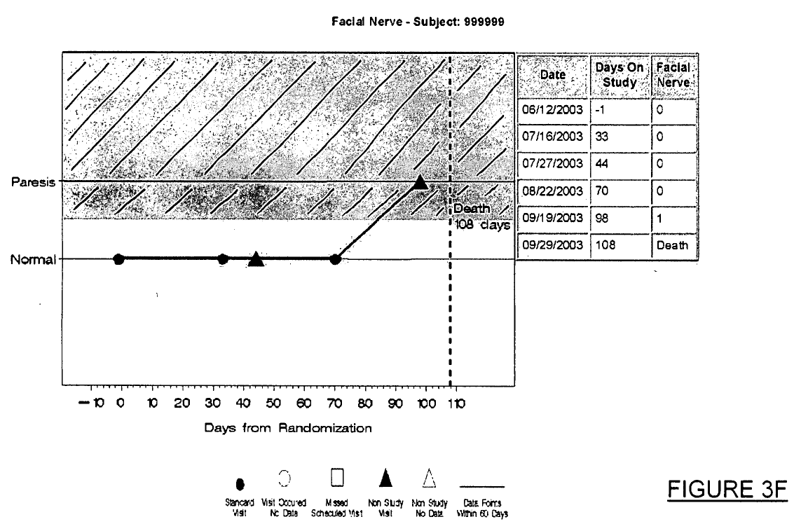

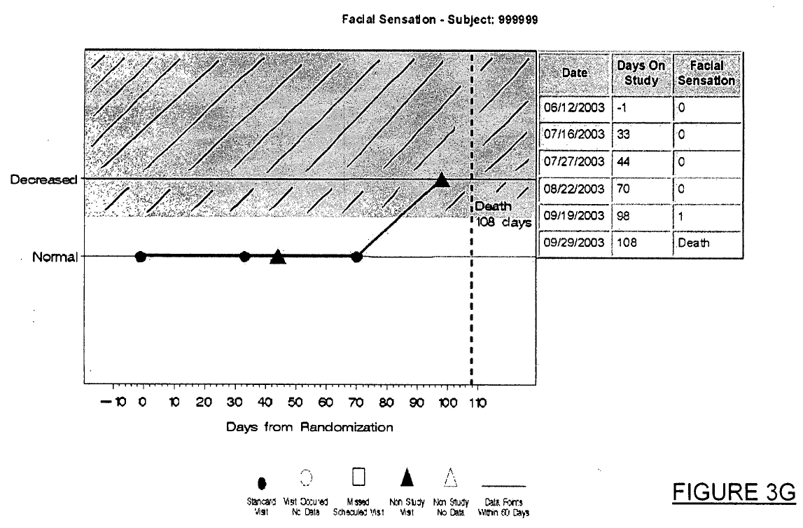

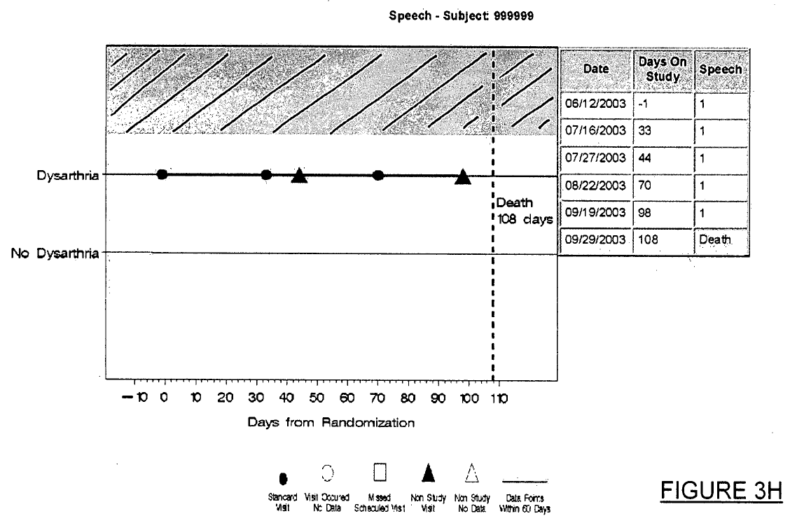

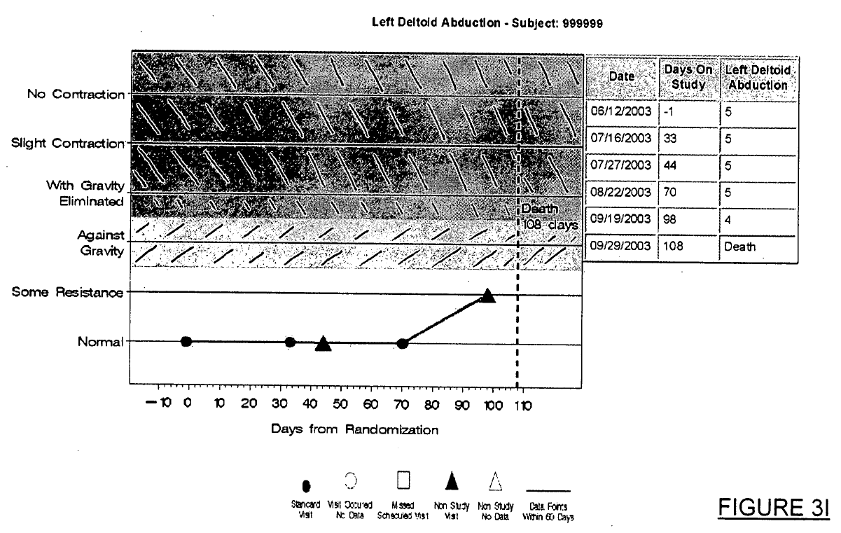

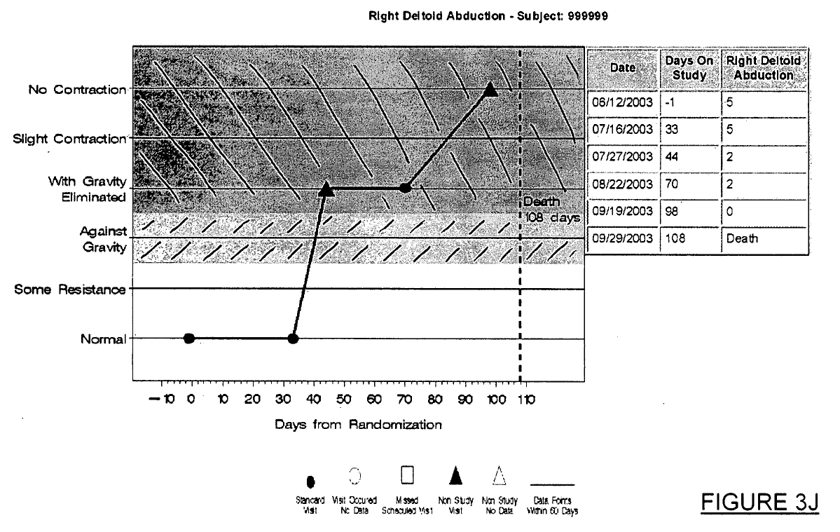

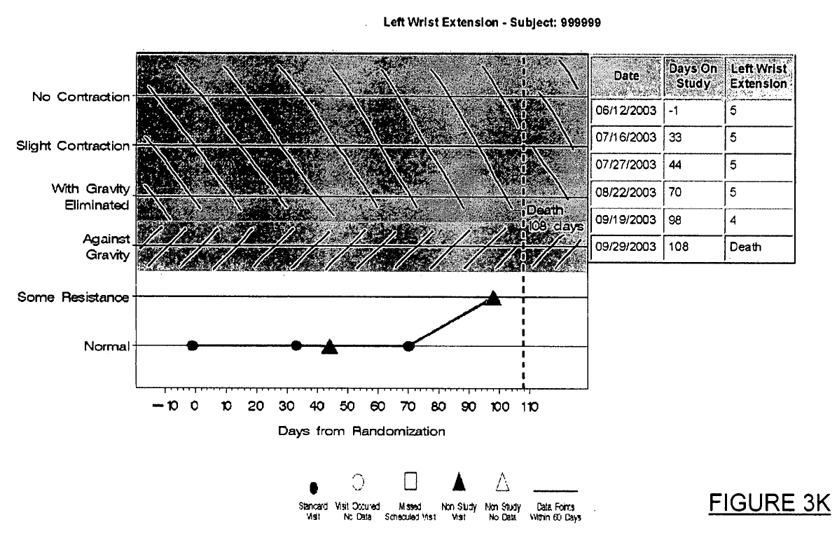

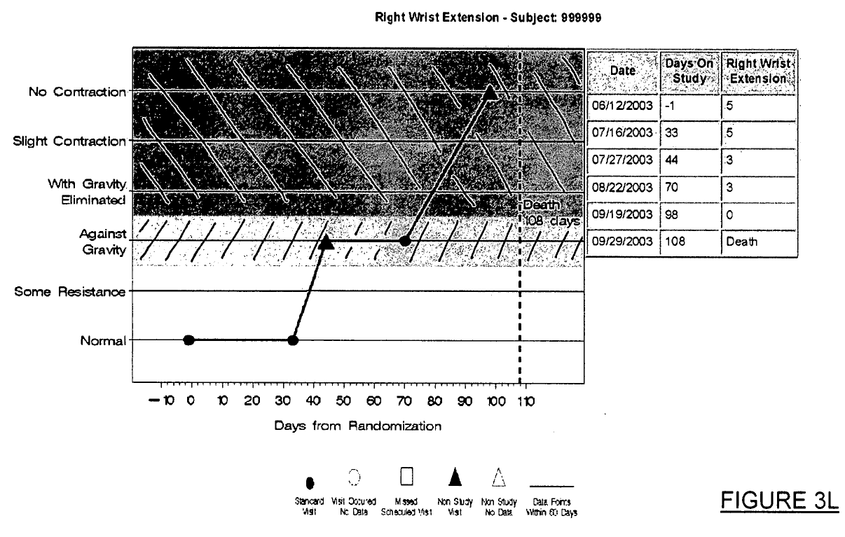

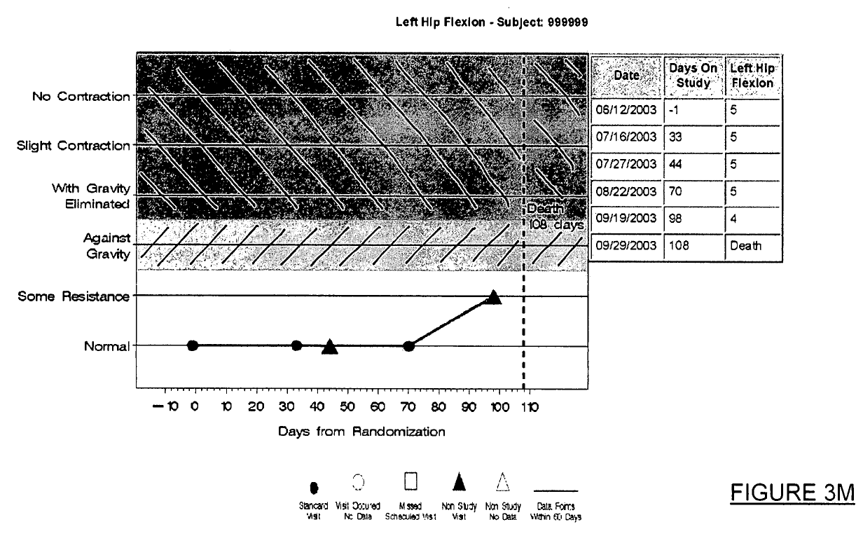

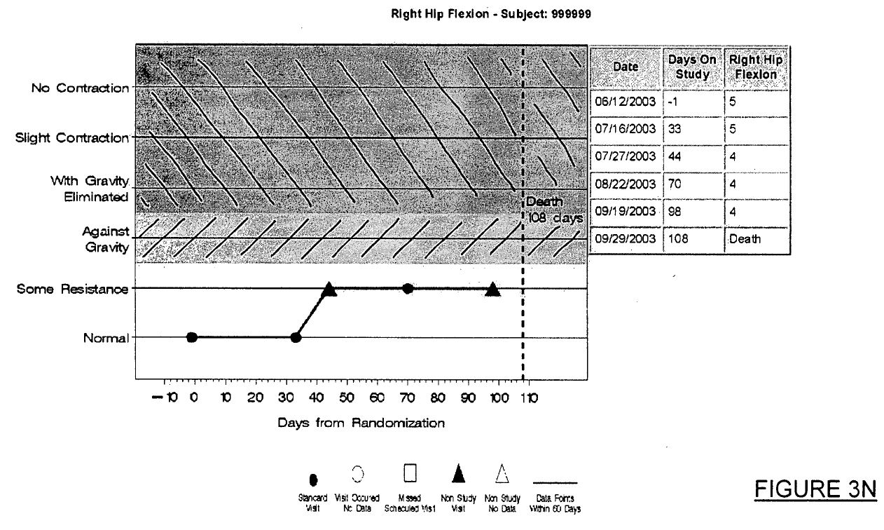

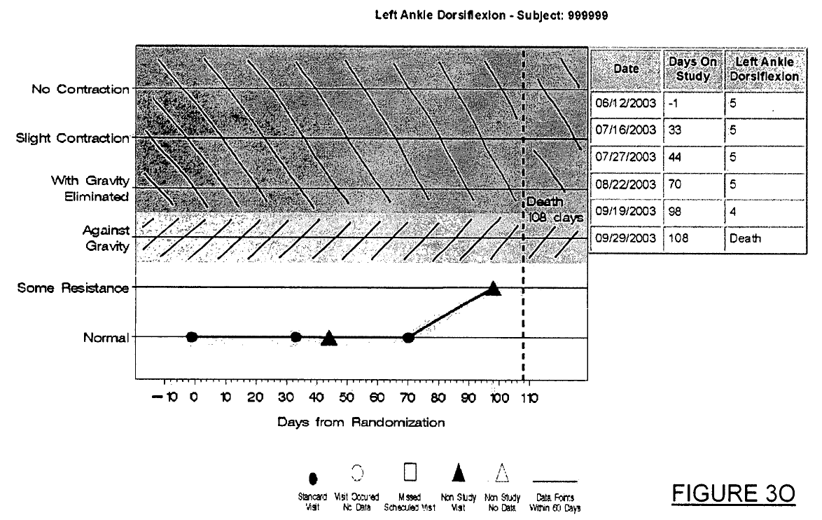

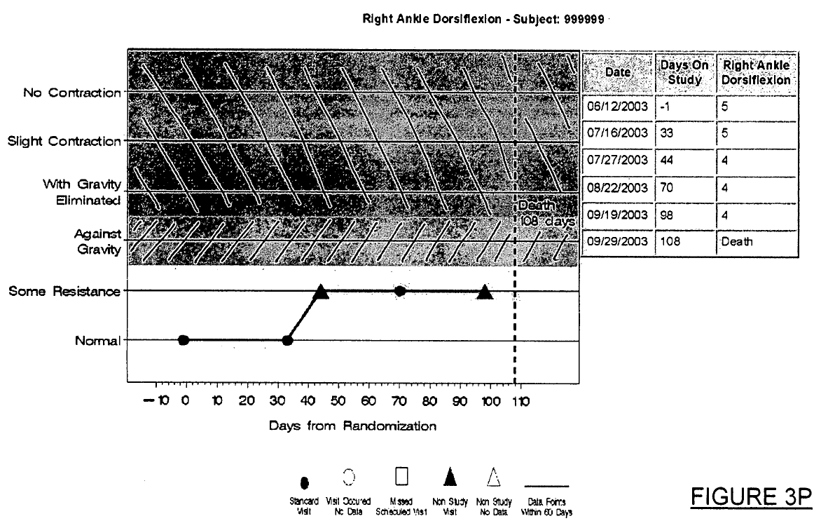

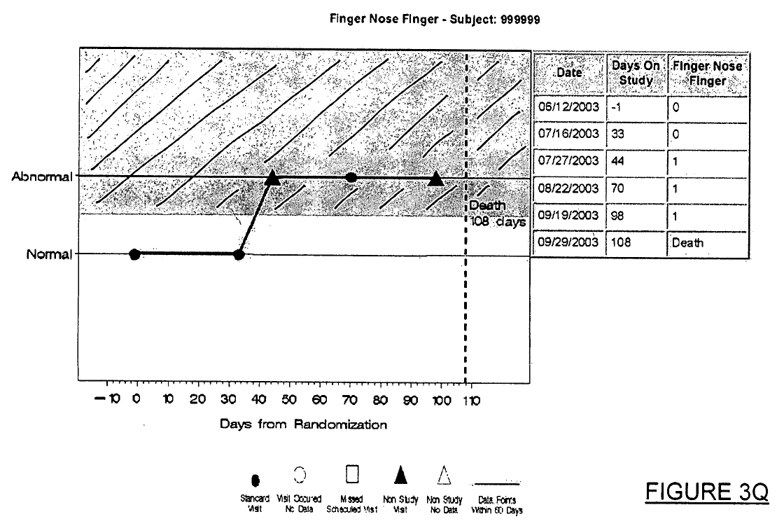

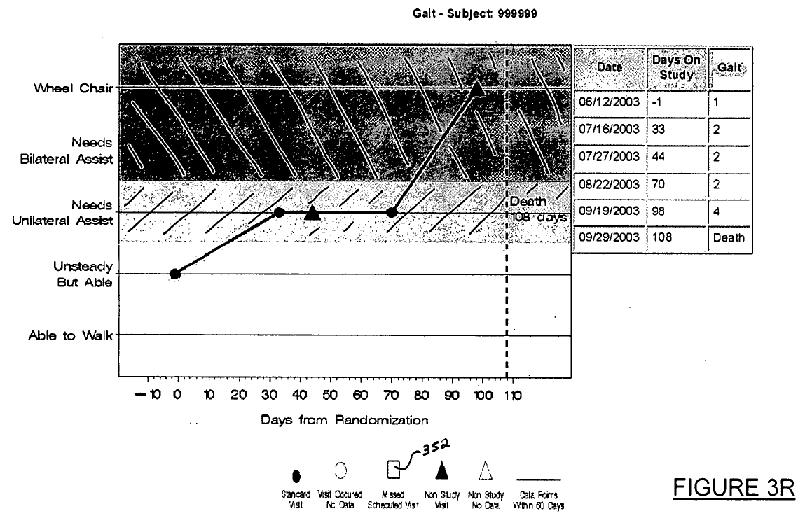

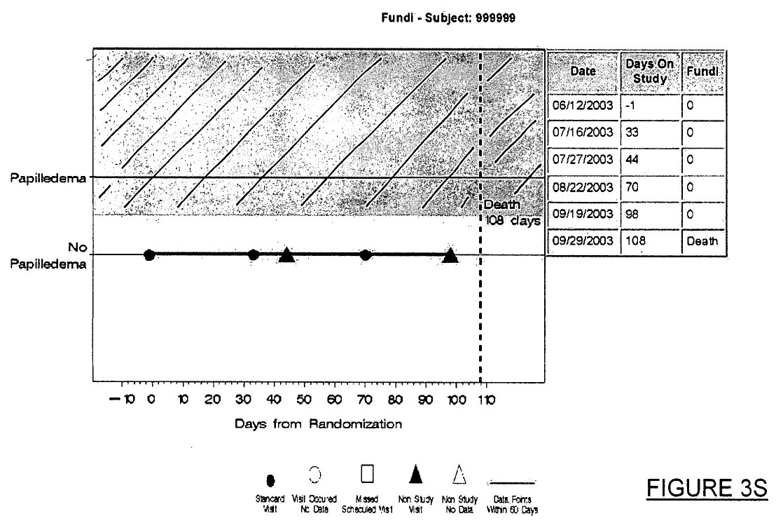

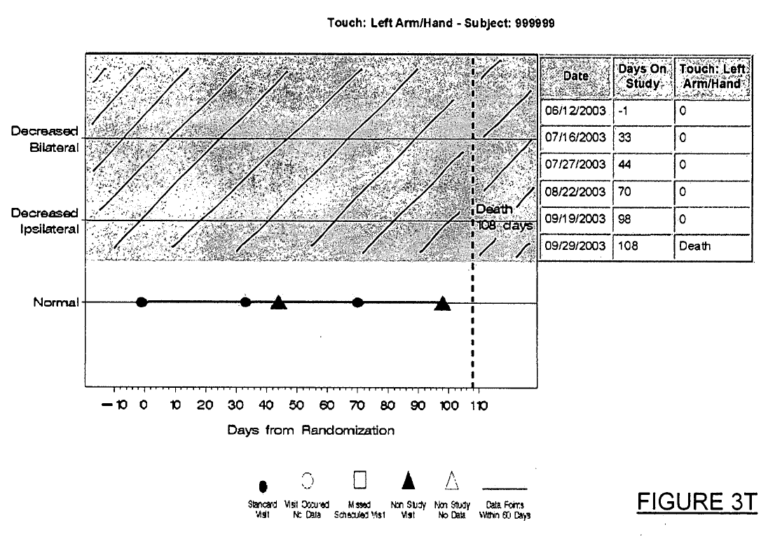

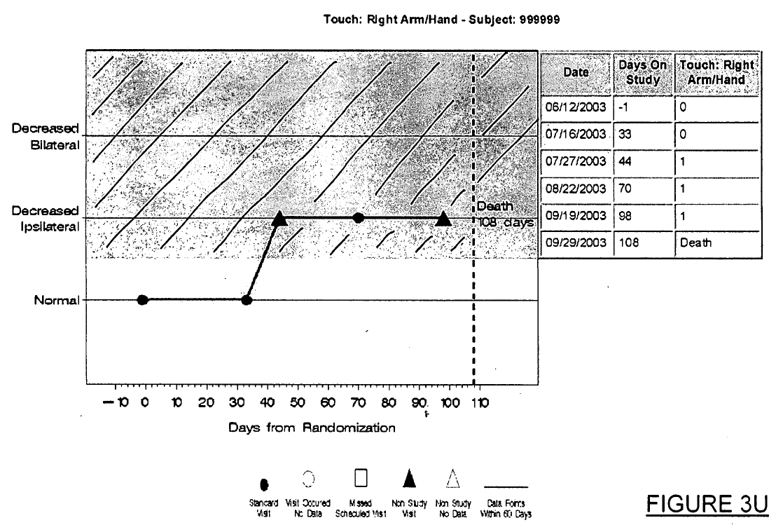

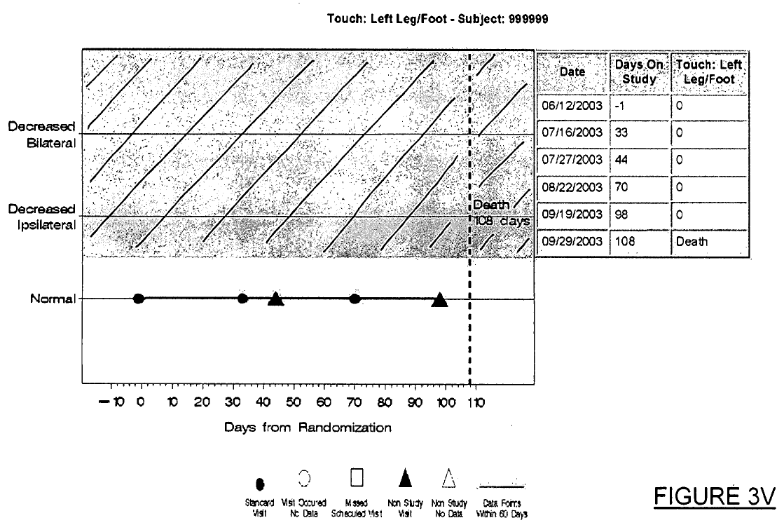

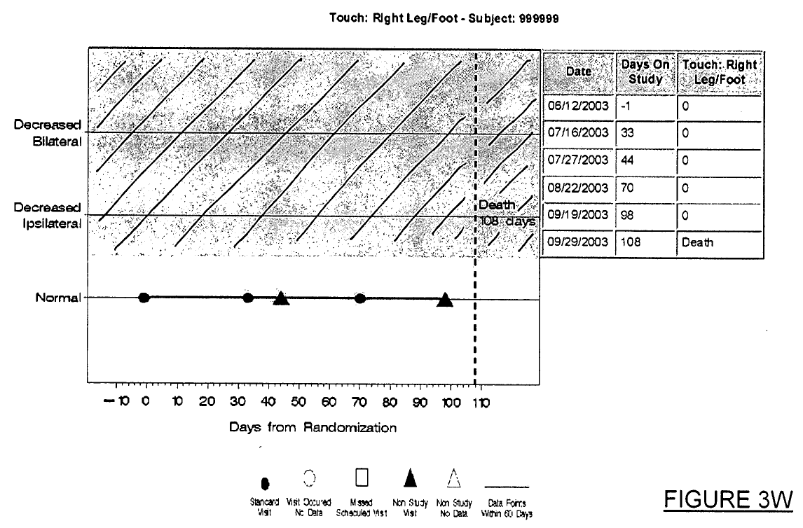

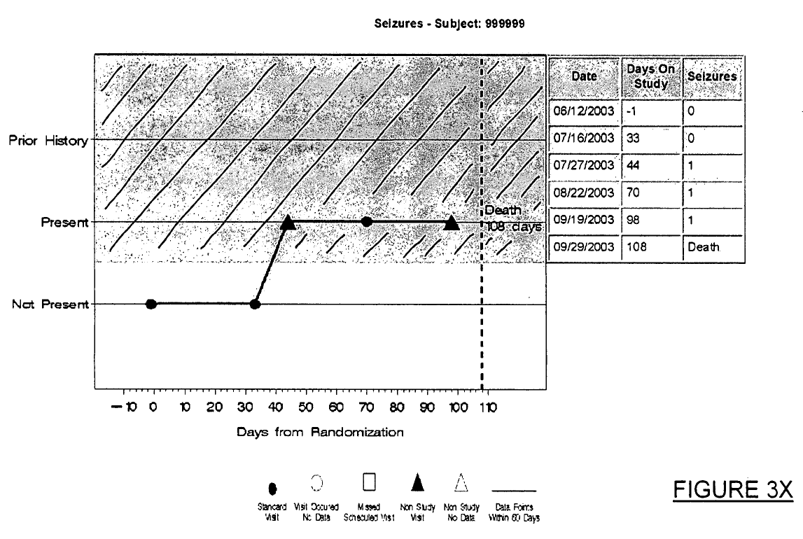

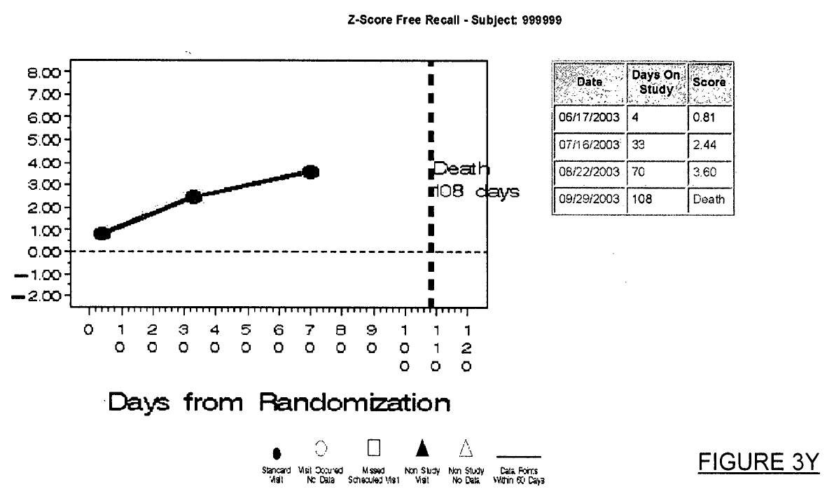

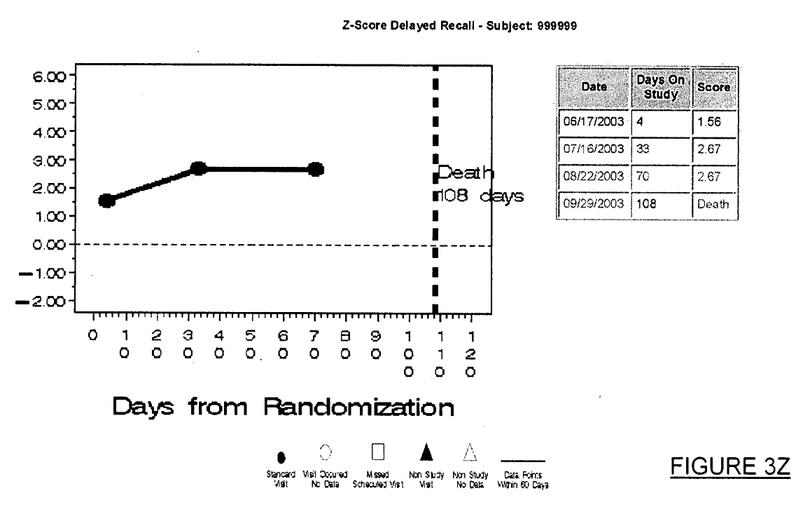

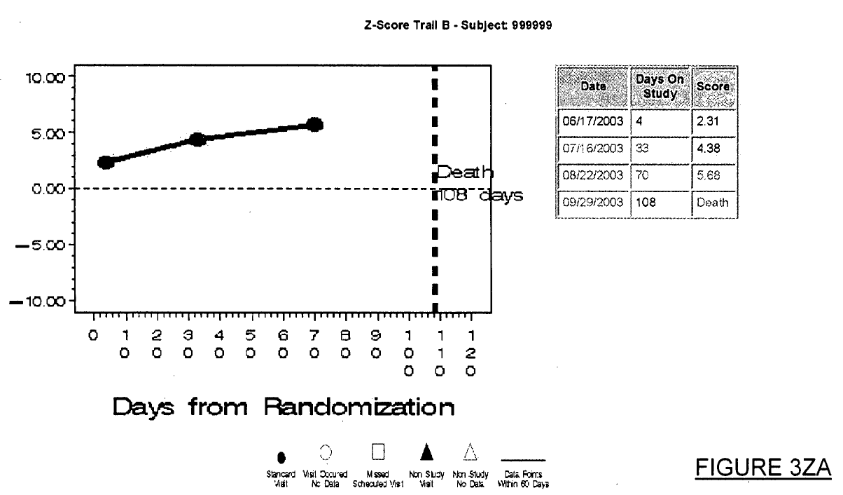

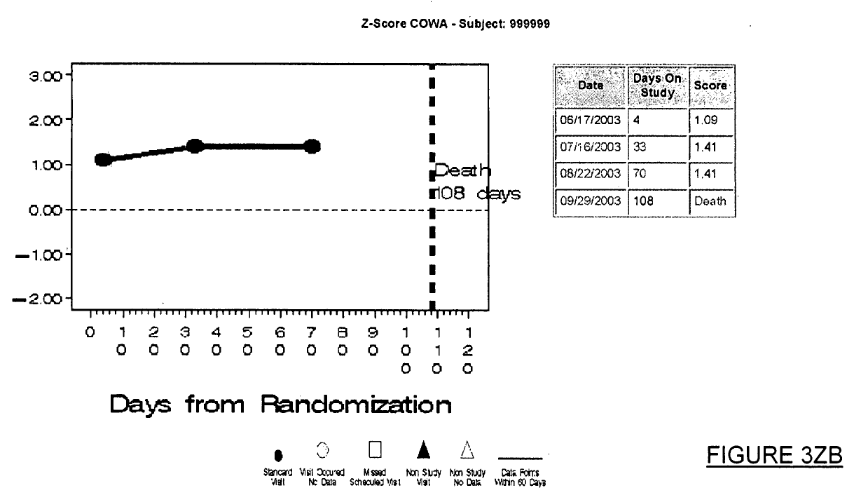

FIG. 2 shows the result of activating link 151, specifically a major neurologic progression criteria table showing the effects of tumor growing in the right frontal lobe. The data of FIG. 2 is displayed in a tabular format with the clinical findings listed down the left hand side, and the data points across in rows. FIG. 3 shows the result of activating link 152, specifically a corresponding minor neurologic progression criteria table. For purposes of providing a variety of data to illustrate operation of the electronic document, FIG. 3 shows the effects of tumor growing in the right, rather than the left, frontal lobe.

Displaying the data in the manner FIGS. 2 and 3 shows all data points in a time dependent context. Some findings (such as gait) may qualify for either major or minor criteria, depending upon their severity, and are thus shown in both FIGS. 2 and 3.

Change from baseline is displayed where relevant in both FIGS. 2 and 3. The major and minor criteria are programmatically identified and highlighted with color-coding. Yellow or red (indicated by hashing) indicate that a minor or major neurologic progression criterion, respectively, has been met.

To facilitate a user of the software package following progression after an event, clinical findings list on the left of the tables of FIGS. 2 and 3 are connected by a link to graphs and tables showing time-evolution of the particular sign or symptom. For example, activation of link 270 of FIG. 2 results in the display of the screen of FIG. 3R, showing a graph and listing for the criteria of gait. As gait is both a major and a minor criteria, the screen display shown in FIG. 3R may be accessed from either link 270 of FIG. 2, or link 372 of FIG. 3.

FIG. 3R indicates that for patient 999999, the condition improves from baseline, but then deteriorates during follow-up. Color coding for minor (forward hash) and major (back hash) criteria are dynamically relocated from the baseline score.

The graph of FIG. 3R shows the change in signs or symptoms over time, and indicates the specific nature of the visit, for example whether the it took place at a study center versus non-study center. Line 354 connecting the data points 356a-e of graph 348 is programmed to be continuous only if the data points lie within a certain time period, in this specific example within 60 days of each other.

To increase continuity between tables and graphs, all data points, including missing data, are displayed. If additional information is available, for example a reason for missing a visit, this data will be available in the electronic package in a separate listing through a link from this location.

For example, the indication of “Missed Visit” in FIG. 3R, is hyperlinked by link 352 to the additional table shown in FIG. 15, which provides more information about this event. Such continuous internal links allow relevant contextual information to be easily accessible to the user at all times within one or two clicks.

As shown in each of the screen displays of FIGS. 2A-2B, the major criteria listed in the table of FIG. 2 are linked to specific relevant plots of time progression. And as shown in each of the screen displays of FIGS. 3A-3ZB, each of the minor criteria listed in the table of FIG. 3 are linked to specific relevant plots of time progression.

Direct comparison of graphical displays showing the progression of different major or minor criteria may be useful in identifying the underlying sources of patterns of change. For motor function, patterns of all strength measurements may be displayed and used to determine if the motor strength neurologic progression criteria have been met. Thus in the embodiment illustrated, motor strength from both the major and minor criteria tables of FIGS. 2 and 3, link to a combined graphic display with measurements of eight motor groups.

FIG. 17 shows such a combined graphic display, where the arrangement of data allows determination if weakness is tumor related, or due to general muscle atrophy from other causes. Within the display of FIG. 17, each graph is then hyperlinked to the same relevant display (with table) as is shown in FIGS. 3K-P.

The arrangement of all motor strength graphs in FIG. 17, facilitates identification of patterns indicating the cause of a motor strength change. Here, FIG. 17 indicates that there is likely a tumor in the motor cortex of the left frontal lobe, as indicated by the disproportionate weakening of the right side.

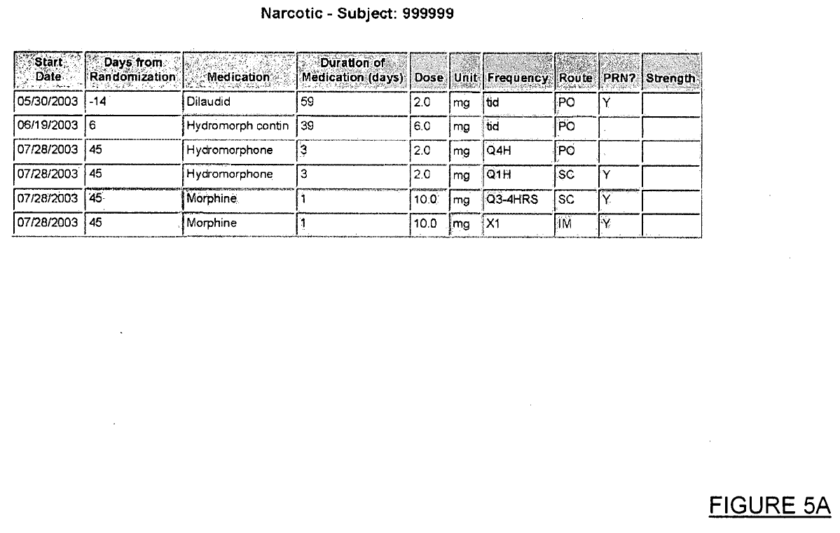

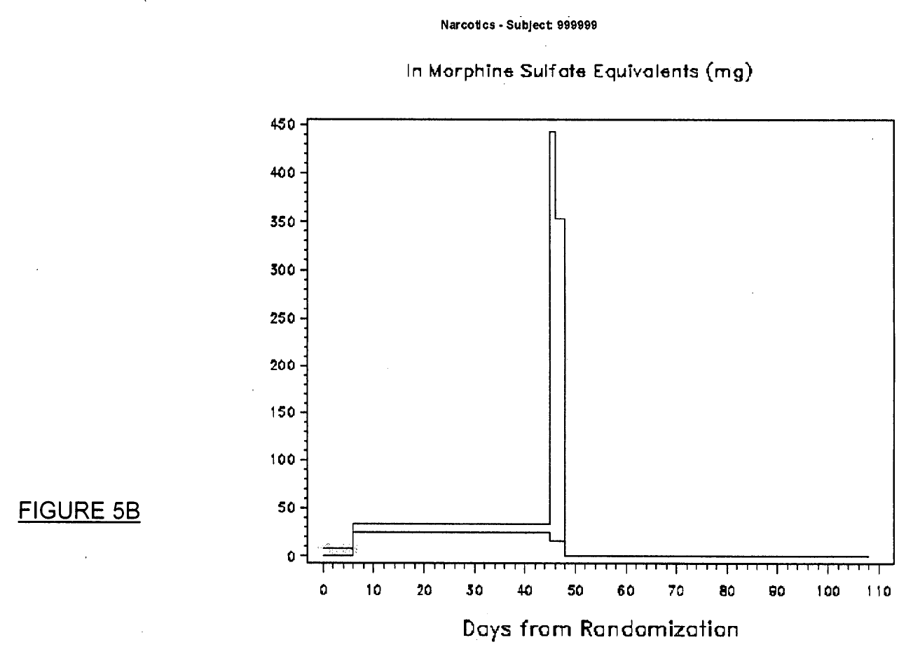

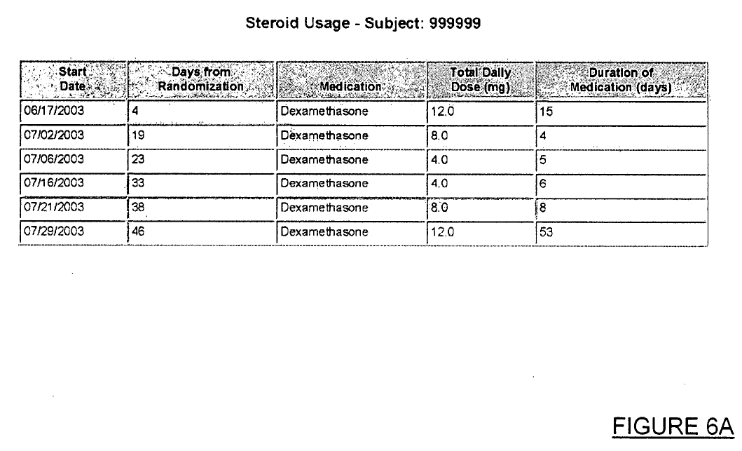

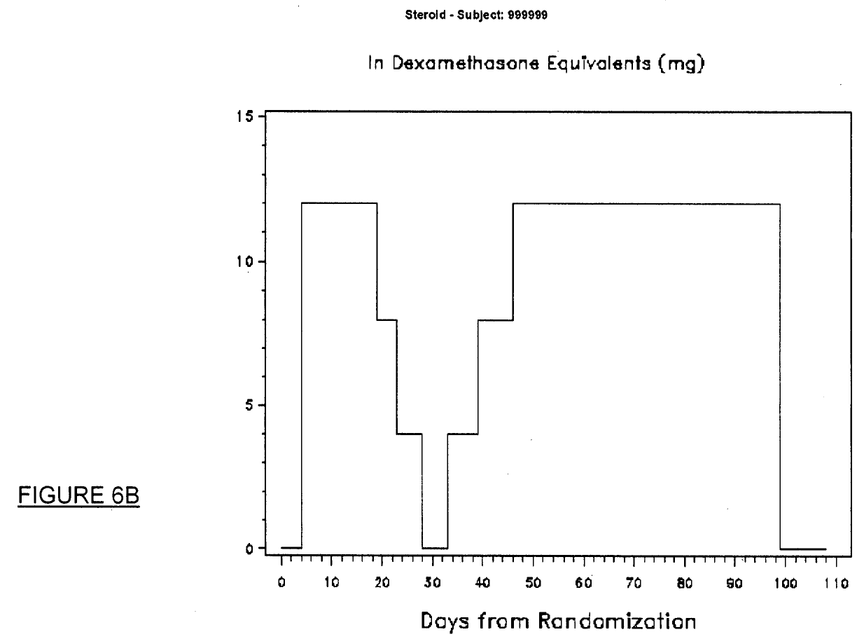

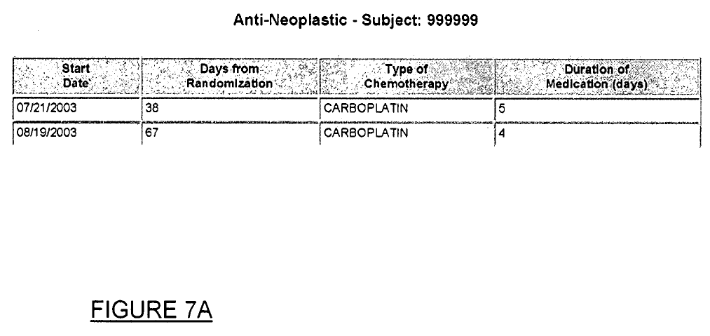

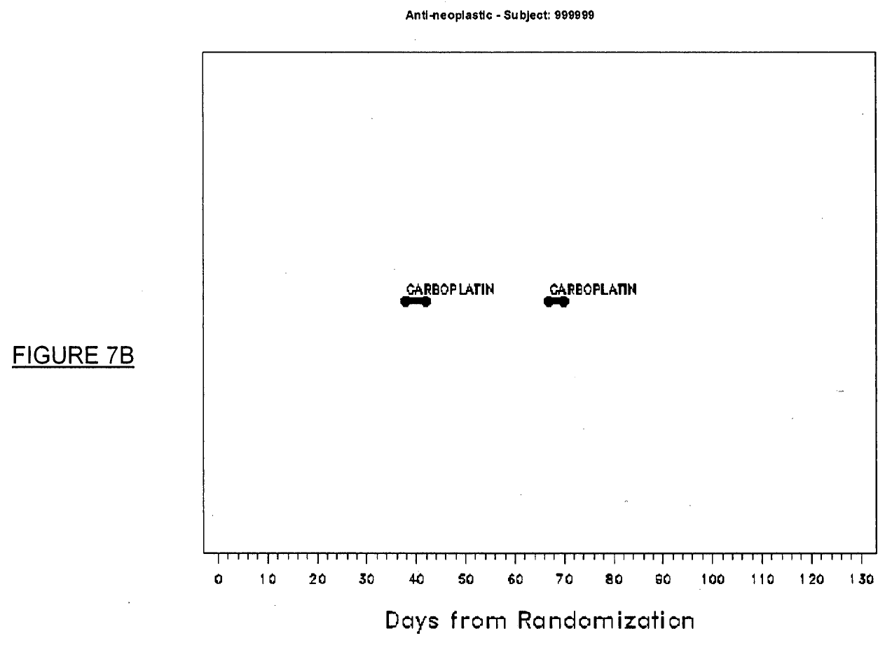

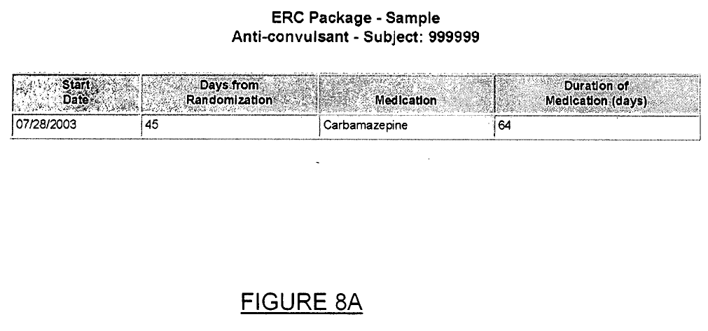

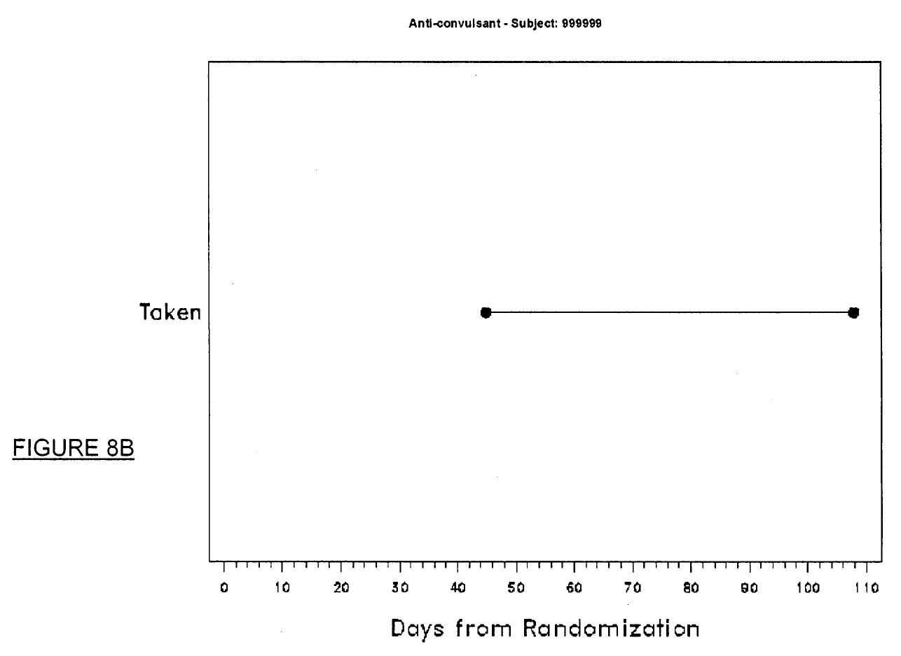

Medication information may also need to be reviewed to determine if drugs or other therapies may have influenced neurological findings. Accordingly, the Table of Contents 150 of FIG. 1 includes links 154-161 to a plurality of other screen displays relating to specific medications. Specifically, FIGS. 5A-B display incidences of the administration of narcotic medication, and FIGS. 6A-B display incidences of the administration of steroid medication. FIGS. 7A-B display incidences of the application of anti-neoplastic therapies, and FIGS. 8A-B display incidences of the application of anti-convulsant medication.

Medication events may be displayed in both a tabular manner and in a graphic manner as shown in the relevant Figures. To standardize interpretation, steroids are converted to dexamethasone equivalents (FIG. 6B) and narcotics are converted to morphine equivalents (FIG. 5B).

As described above, indication of progression of the neurological disorder is derived by comparison of patient data to a rule set. In the specific example described herein, the rule set is as follows.

For any functional neurocognitive test, an increase of 2 or more in the z-scores, i.e., deterioration from the screening score by two standard deviations (based on the normative population) or more, which is confirmed on a subsequent visit, constitutes a deterioration. A deterioration of 2 or more in the z-score on the last assessment before death or study termination constitutes a deterioration if the last assessment was made within 2 months of the date of death or study termination. If a test is marked with a “*” for disability in the case of missing neurocognitive scores, as described in section 4.2.1, the ERC will not consider the neurocognitive function to have declined regardless of the cause for the missing value.

Patients found to meet any one of the major criteria during study follow-up will be considered to have neurologic progression at that time. Major criteria are signs found upon a neurologic examination that are most specific for an acute deterioration caused by a brain tumor and have a profound effect upon a patient's neurologic status. No confirmation is required for a major criterion found upon neurologic examination.

Patients experiencing a changed level of consciousness, i.e. who become stuporous or comatose during the course of study follow-up will be scored as having a neurologic progression at the time of the event if evidence of other systemic causes has been effectively ruled out. Data, including laboratory evaluations, will be available to rule out drug-induced changes, decline in pulmonary function, metabolic changes in electrolytes or glucose, overwhelming infection, and hepatic or renal failure.

Patients found to have new onset aphasia or dysphasia will be scored as having a neurologic progression.

Motor strength is another major criterion. Patients found on physical examination to have a greater than or equal to 3-grade change from baseline in motor strength in a limb will be scored as having a neurologic progression. Investigators will rate patient motor strength using standard physical exam criteria:
5=Active movement against full resistance without evidence of fatigue (Normal muscle strength)
4=Active movement against gravity and some resistance
3=Active movement against gravity
2=Active movement of the body part with gravity eliminated
1=A barely detectable flicker or trace of contraction
0=No muscular contraction detected
   The user of the electronic package may evaluate the global motor strength in all limbs proximally and distally to ensure that the weakness is not attributable to corticosteroid myopathy.

The appearance of a new visual field defect is a major criterion of progression. Patients developing a new visual field defect will be scored as having a neurologic progression.

Ataxia is a major criterion of progression. Patients developing a 2 grades or greater worsening from baseline in their gait will be scored as having a neurologic progression. Gait abnormalities cannot result solely from lower extremity motor weakness. Ataxia will be scored according to the following scale:
0=No evidence of ataxia
1=unsteady but able to walk
2=able to walk with unilateral assistance
3=able to walk with bilateral assistance
4=requires wheelchair, unable to walk

Executive function is also a major criterion. Executive function is felt to be the most specific indicator of neurologic deterioration found on neurocognitive testing that can result from the presence of a brain tumor. Patients developing a 2 or greater deterioration from baseline in their z-scores on the Trailmaking Test B and COWA Test will be scored a neurologic progression. Both of the deteriorations in these tests must be confirmed on consecutive study visits unless both deteriorations are found on the last visit before death, study termination or before additional brain directed therapy (see below for the allowable time intervals).

Minor criteria comprise a set of findings consistent with the worsening of a brain tumor, but each finding by itself is not sufficient to declare neurologic progression. In order for a patient to be considered as a neurologic progression, s/he must have an initial combination of 3 minor criteria, followed by confirmation on a subsequent visit (see below).

Change in orientation is a minor criterion. A change in orientation from baseline affecting 2 of 3 areas (person, place or time) would be considered a minor criterion. In order to be oriented to person, the patient must be able to identify him/herself. In order to be oriented to place, the patient must be able to identify the location (e.g. hospital). In order to be oriented to time, the patient must be able to identify the month and year.

Change in motor strength of 2 grades or more is also a minor criterion of neurologic progression. A 2-grade change from baseline in motor strength in a limb will be considered a minor criterion. The motor strength scale is presented below. The ERC will evaluate the motor strength of all limbs to ensure that the weakness is not attributable to corticosteroid myopathy.

Loss of sensation in a limb is a minor criterion of neurologic progression. Loss of light touch sensation in a limb will be considered a minor criterion. At study visits, investigators will assess patients for loss of light touch in the limbs.

Facial weakness is a minor criterion of neurologic progression. The development of a new facial weakness will be considered a minor criterion. Facial numbness is also a minor criterion of neurologic progression. The development of new facial numbness will be considered a minor criterion. Changes resulting in unequal or unreactive pupils during study follow-up will be considered a minor criterion.

The development of new dysarthria will be considered a minor criterion. Upon fundoscopic examination, the detection of new papilledema will be considered a minor criterion.

The development of an oculomotor palsy because of deficits in cranial nerves III, IV or VI will be considered a minor criterion. To assess for oculomotor palsy investigators will be asked to assess patients for deficits in extraocular motion or symptoms of double vision that resolve when one eye is covered.

New abnormalities detected upon assessment of cerebellar function using the finger-to-nose-to-finger test will be considered a minor criterion in the absence of motor weakness in the upper extremity used during this examination.

The development of a 1 grade worsening in a gait abnormality (Ataxia) comprises a minor criterion. Gait abnormalities are graded according to the scale set forth below. Investigators will assess gait by asking patients to walk, if possible, unassisted.

Changed eurocognitive tests may also be a minor criterion of neurologic progression. A worsening of a z-score by 2 in the Hopkins Verbal Learning Tests (recall, delayed recall), the Trailmaking Test B, or the Controlled Oral Word Association Test will be considered a minor criterion. If multiple tests within the same functional domain worsen, they will only count as one minor criterion (eg, worsening in the Hopkins Verbal Learning Tests (recall and delayed recall) on the same visit are considered as 1 minor criterion). Hopkins Verbal Learning Test (recognition) and Trailmaking Test A, because of their low sensitivity, will not count towards the minor criteria.

The development of new seizures during the study follow-up period will be considered a minor criterion. If the patient has a prior history of a seizure, worsening of the seizure type or increasing frequency would not meet the criterion. Once a diagnosis of seizure activity is established, further new diagnoses of the same seizure activity cannot be repeated; this criterion will not require confirmation and will be considered a minor criterion from that point forward. However, when other data are available, other causes of seizures will be ruled out to establish a brain metastases etiology.

To be scored as a neurologic progression, the quantity and consistency of the minor criteria must be confirmed on subsequent visits. Because a visit interval shorter than 14 days does not allow for a criterion to be established with certainty as persistent, confirmation of minor criteria cannot occur on a study visit recorded less than 14 days after the initial presentation of the minor criteria. A visit interval extending greater than 2 months represents a long enough time period that the user may be unsure of the clinical condition of the patient remains the same throughout that interval. If the next available study visit does not occur until greater than 2 months after the initial presentation of the minor criteria, the minor criteria cannot be confirmed even if the same minor criteria persist. The minor criteria seen on the second visit, more than 2 months after initial presentation, must also be confirmed on another study visit between 2 weeks and 2 months later.

In order for any combination of 3 minor criteria to be considered for neurologic progression, at least 3 minor criteria must be found on a subsequent visit that occurs not earlier than 2 weeks and not more than 2 months from the initial presentation and at least one of the findings must be on the subsequent visit. The date of progression will be considered the date on which the 3 minor criteria were initially found. Patients who have 3 minor criteria on consecutive visits in the above timeframe but in which there is not overlap of at least one minor criterion between the visits will not be considered for neurologic progression.

Patients who develop 3 or more minor criteria and then develop a major criterion on the next consecutive visit will be considered to have had a neurologic progression at the time the initial minor criteria arose if the major criterion falls into the same category as any of the previously detected minor criteria (eg progressive worsening of a specific limb in motor strength from 2 grade change to 4 grade change). However, if the major criterion does not overlap, the neurologic progression will be scored as occurring when the major criterion was met.

Patients with brain metastases are often treated with palliative doses of corticosteroids both for initial management and for worsening disease. As a result of this intervention, the corticosteroid may temporarily mask signs or symptoms of neurologic progression. However, corticosteroid treatment does not influence the natural history of the brain metastasis itself and the palliative effects generally do not last longer than 1 month if the tumor continues to progress. A patient may be considered to have a neurologic progression if a sign or symptom returns when the corticosteroid is no longer effective. The following confirmation rules address these clinical situations.

If the patient develops 3 minor criteria and has at least 1 overlapping minor criteria on the 2nd visit, the patient can be scored as a neurologic progression if on a 3rd visit they have at least 3 minor criteria and the one of the initial 3 minor criteria. All of these visits must occur in the 2 week to 2 month window required for confirmatory visits. For example, a patient may present with new onset of a 2-grade decrease in motor strength in the right upper extremity, loss of sensation in the right upper extremity and an abnormal finger-to-nose-finger exam using the left upper extremity. On a visit 4 weeks later, the 2-grade decrease in motor strength persists, but the other signs have abated. On a third visit 6 weeks after the first visit, the decrease in motor strength remains the same and 2 other signs develop. This patient will be scored as having a neurologic progression at the first visit on which the decrease in motor strength was manifest.

Patients may have a decline in neurologic function and as a result receive additional brain directed treatments before a confirmatory visit. Patients who develop at least 3 minor criteria on a study visit and receive additional brain treatment(s) within 2 months of that visit will be scored to have neurologic progression at the time of presentation of the 3 minor criteria. Additional brain treatments include additional cranial radiation of any form, surgical resection of a brain lesion and implanted antineoplastic medications. No current antineoplastic agents are indicated for brain metastases from non-small cell lung cancer so systemic antineoplastic treatment will not be considered an additional brain treatment.

Patients may have a decline in neurologic function and die before a confirmatory visit. Presumably the neurologic decline also contributes to the patient's worsening condition and subsequent death. Patients who develop at least 3 minor criteria on any study visit within 2 months of death will be scored to have neurologic progression at the time of presentation of the 3 minor criteria.

Patients who develop at least 3 minor criteria on a study visit and subsequently are terminated from the study follow-up will be scored as having a neurologic progression at the time of presentation of the 3 minor criteria.

Apart from the major and minor criteria listed in TABLES 2 and 3 respectively, there are a number of other signs and symptoms whose progression may prove valuable in the evaluation of neurological disorders. Accordingly, FIGS. 11A-N plot the incidence of the following: headaches, nausea, vomiting, dizziness, memory loss, personality change, hearing loss, concentration, memory, self-expression, difficulty of thought expression, decision-making, ability to put thoughts together, and ability to put thoughts into action. These charts of other signs may be accessed by the user of the software package through link 164 of the Table of Contents of FIG. 1.

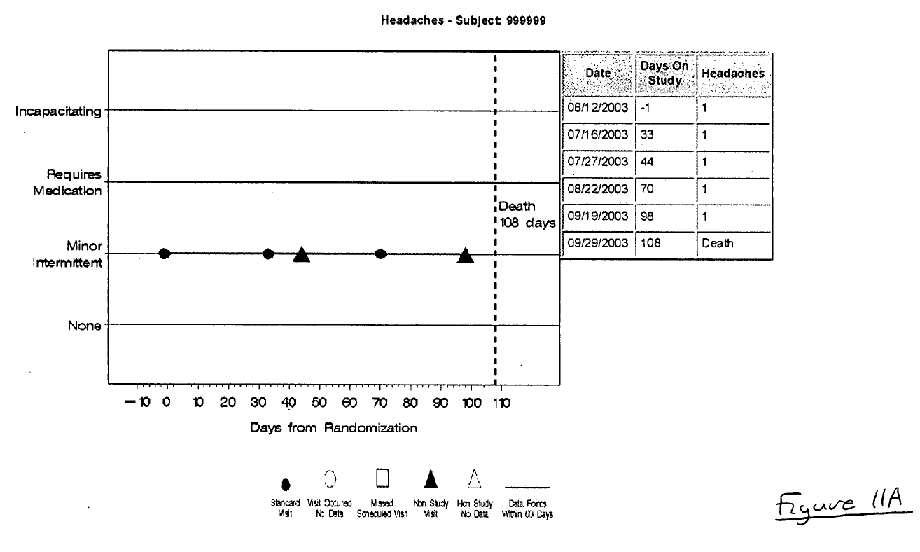

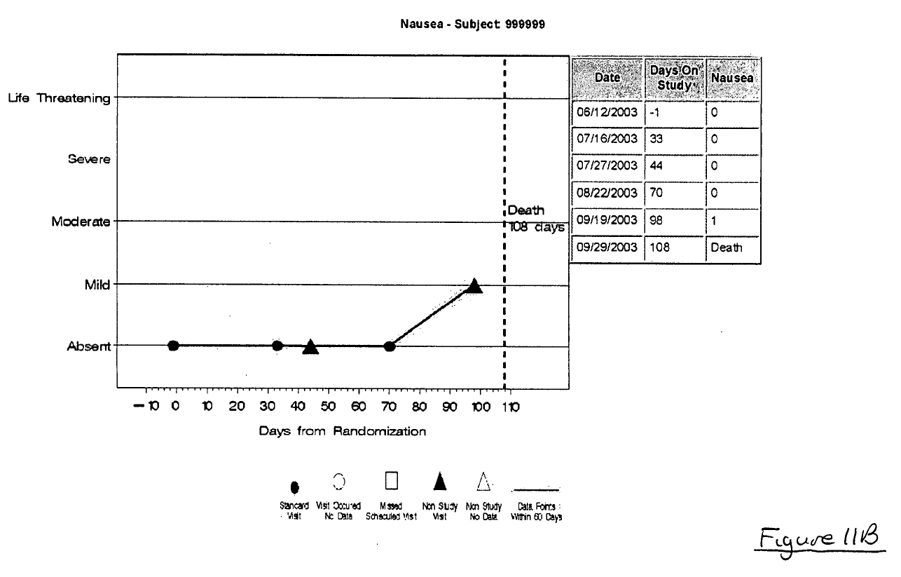

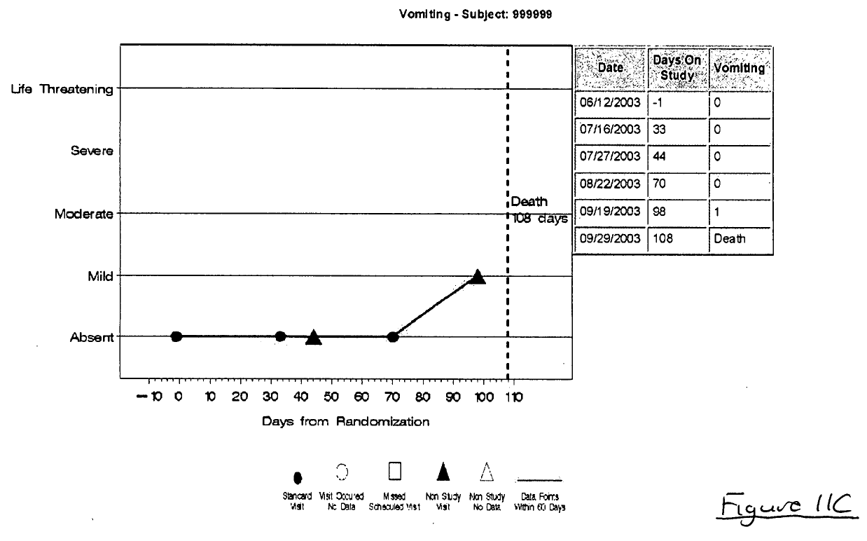

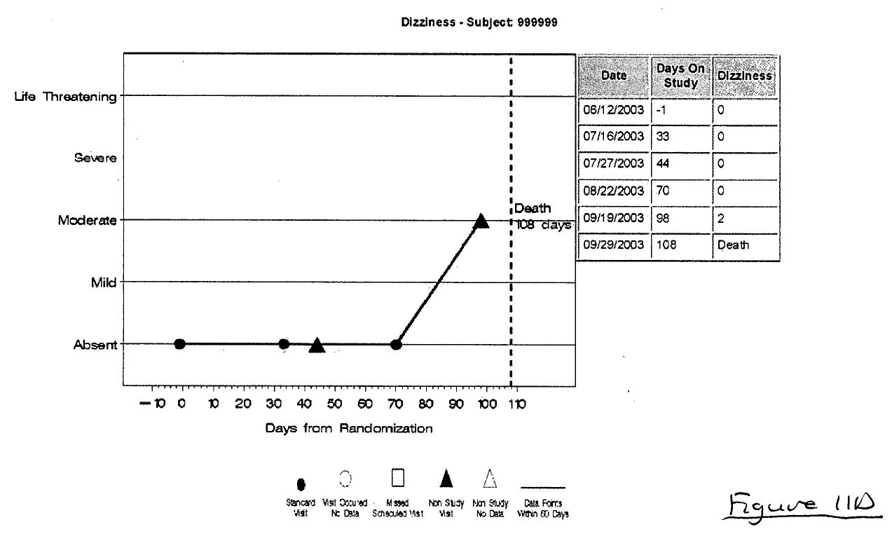

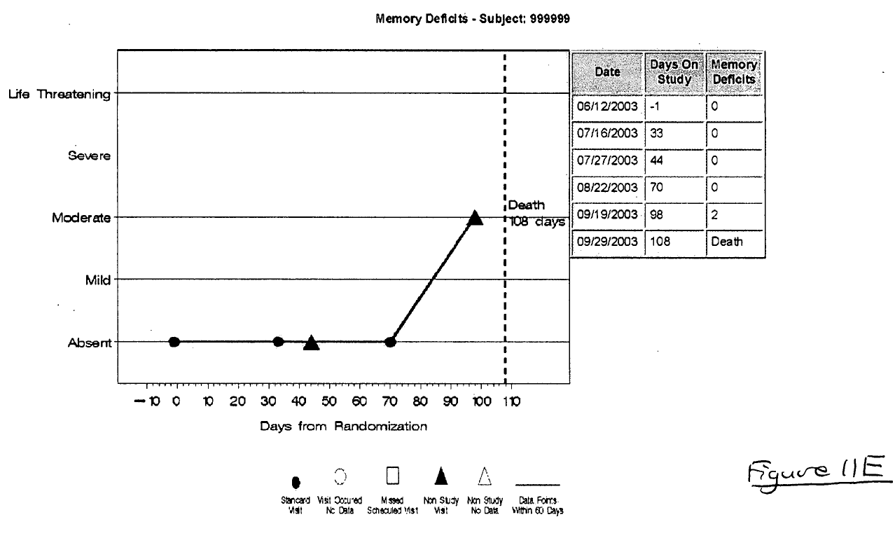

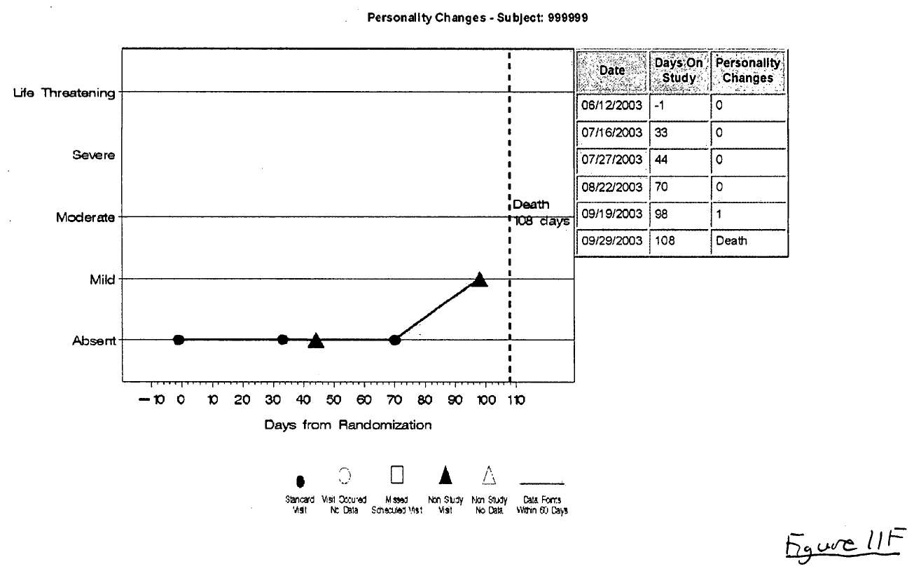

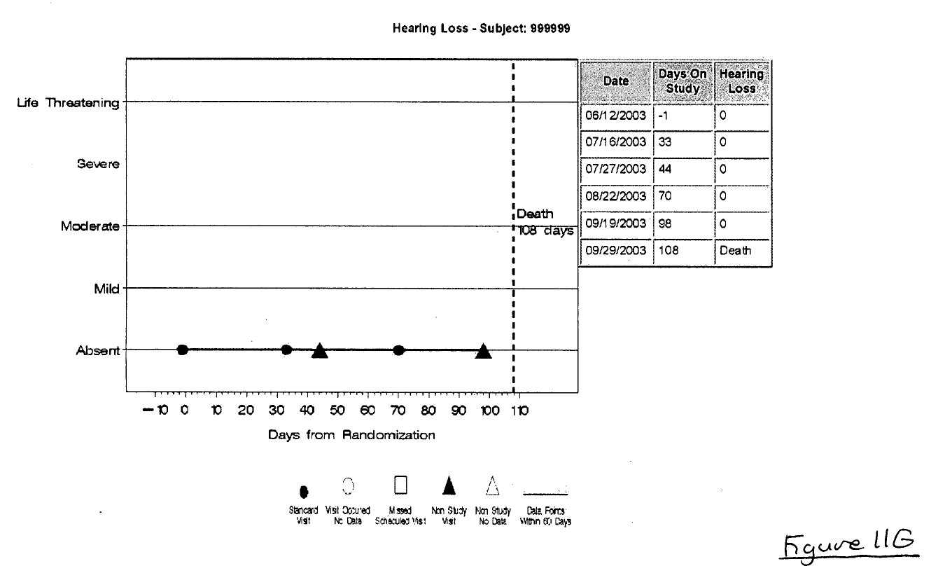

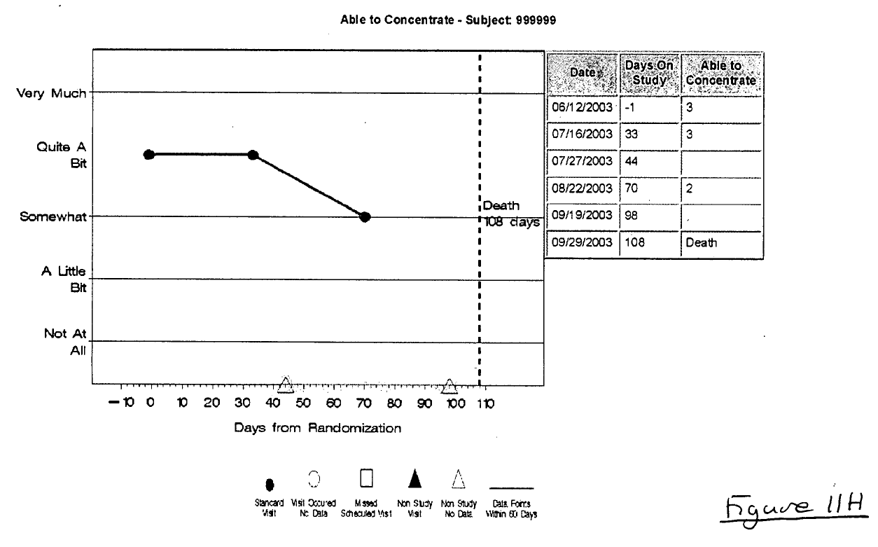

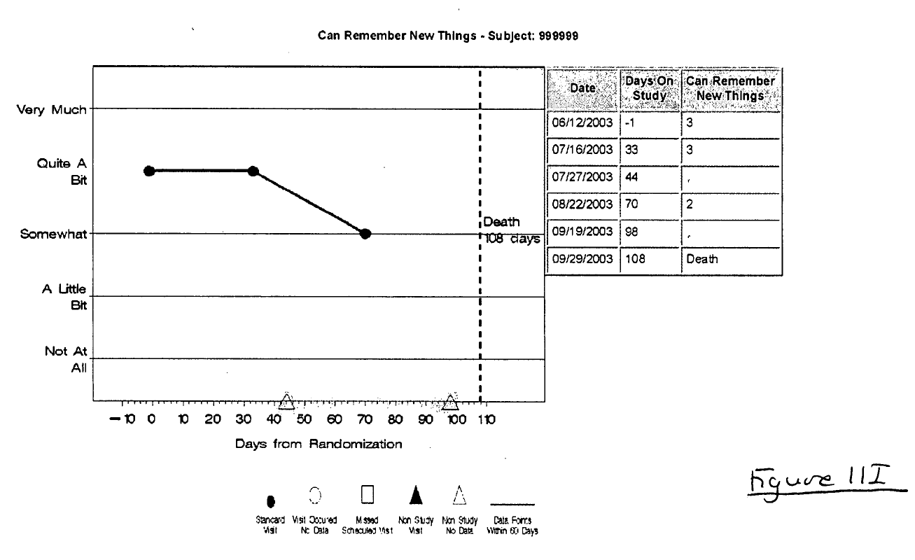

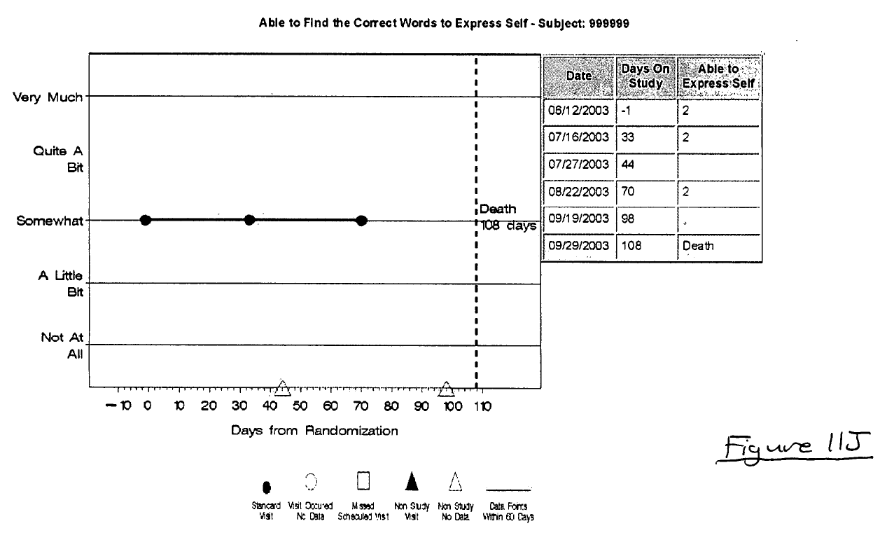

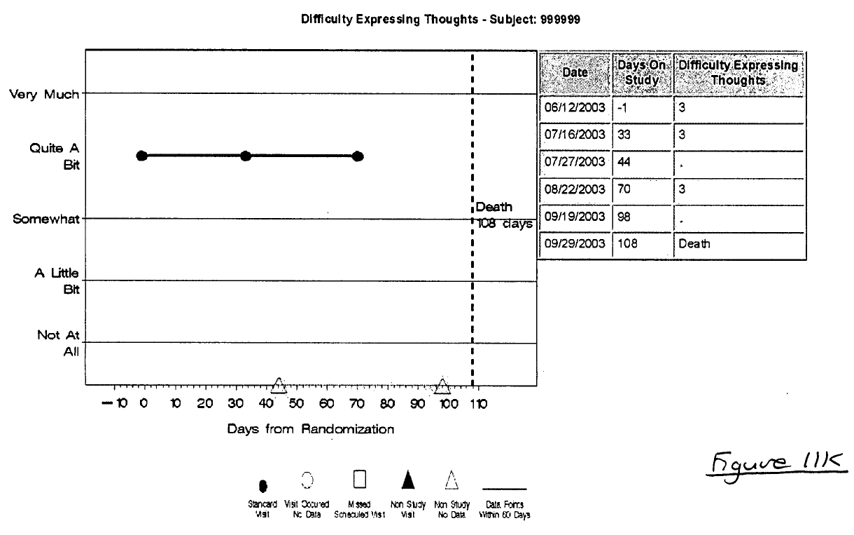

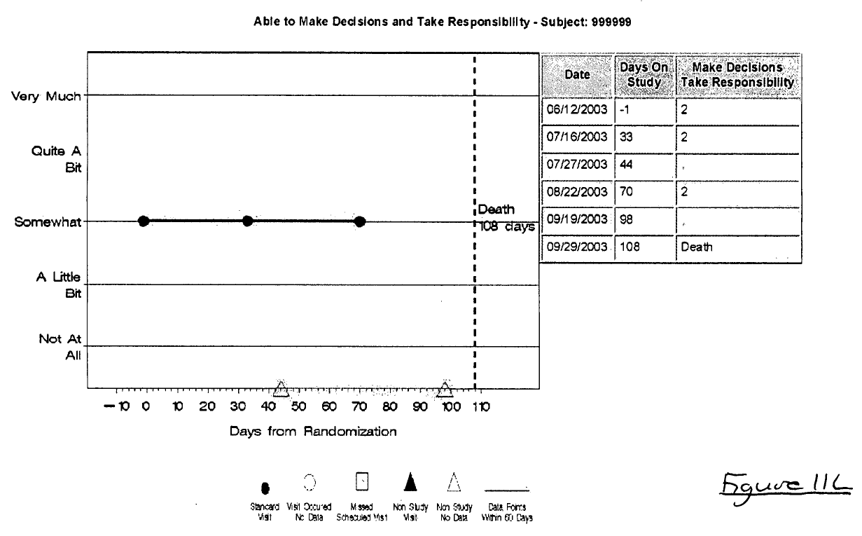

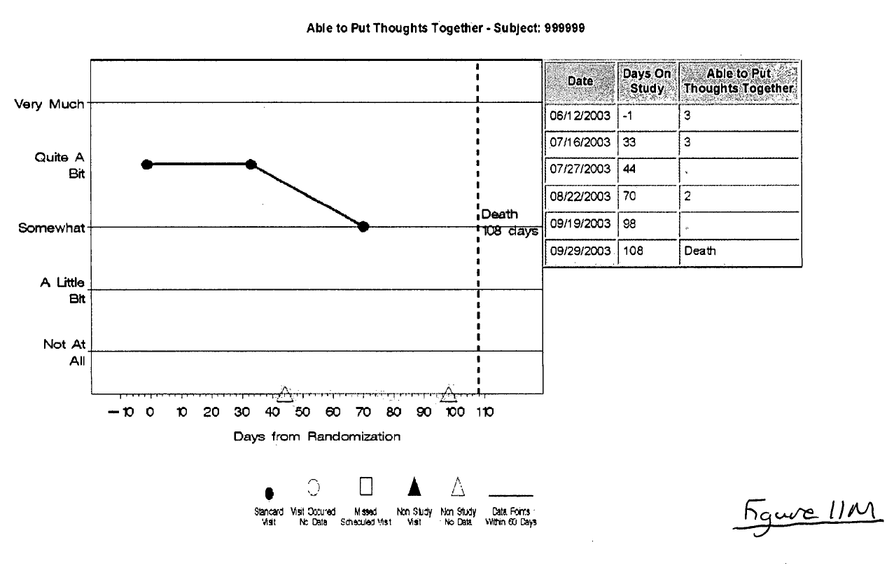

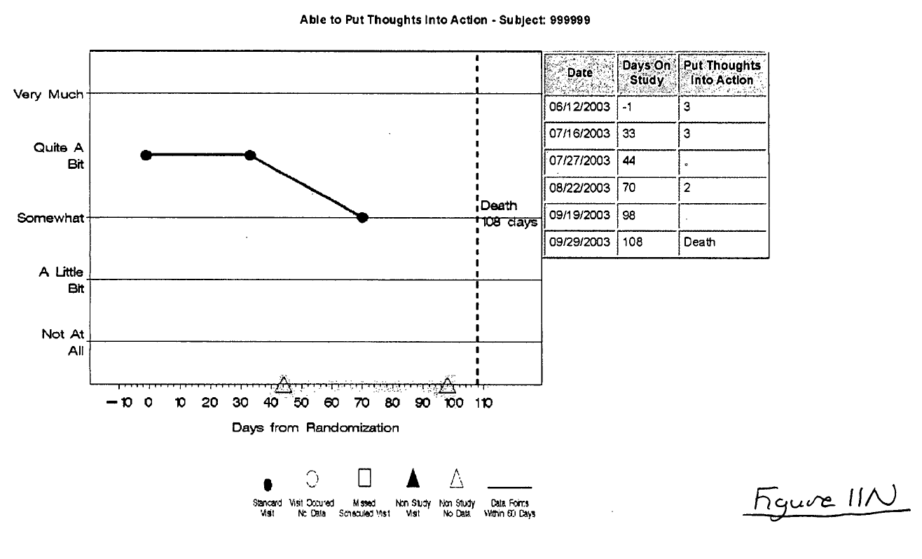

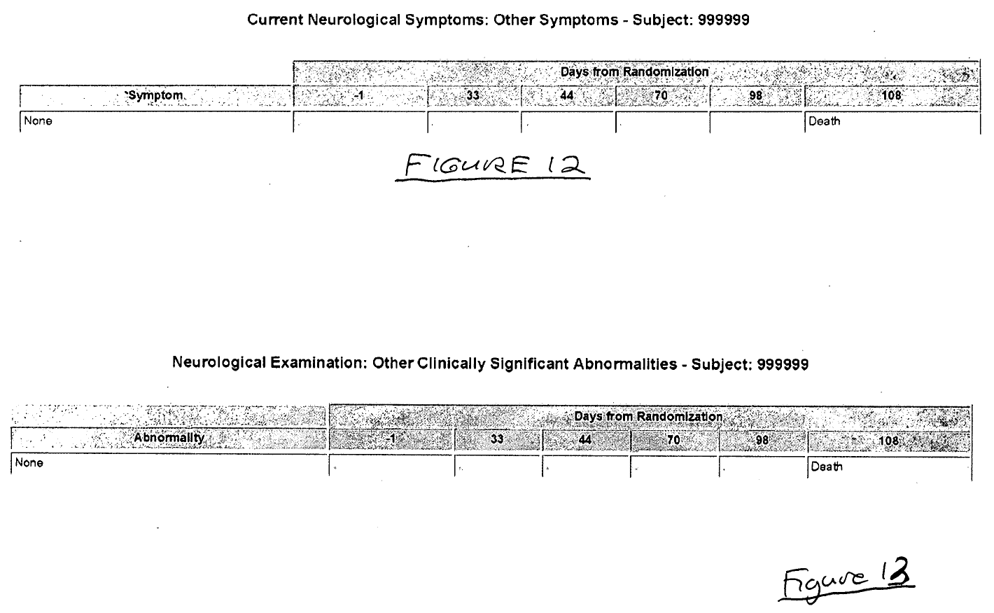

Still other detailed neurological information is available to a user of the electronic document. For example, FIGS. 12-14 indicate pages relating to other symptoms, clinically significant abnormalities, and levels of conciousness, respectively.

FIG. 18 shows a simplified block diagram of the software program that is responsible for generating an electronic document in accordance with an embodiment of the present invention. The software 1800 comprises an input module 1802 in electronic communication with a process engine 1804, that is in turn in electronic communication with predetermined rule set 1806. Based upon input received from module 1802, process engine 1804 extracts relevant data from database 1808 that has been configured to store patient data, including the dates of patient visits. Process engine 1804 then references the rule set 1806 to generate information regarding progression information therefrom. Output module 1810 then assembles the extracted and generated data in order to create the electronic document.

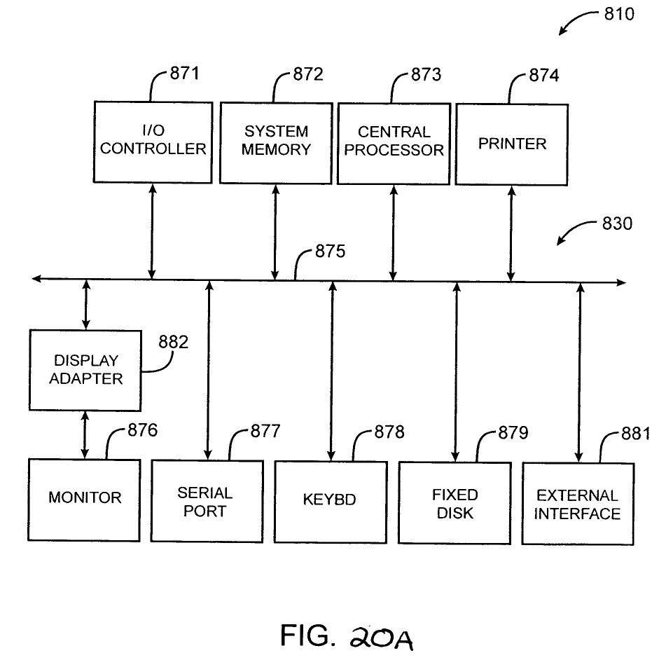

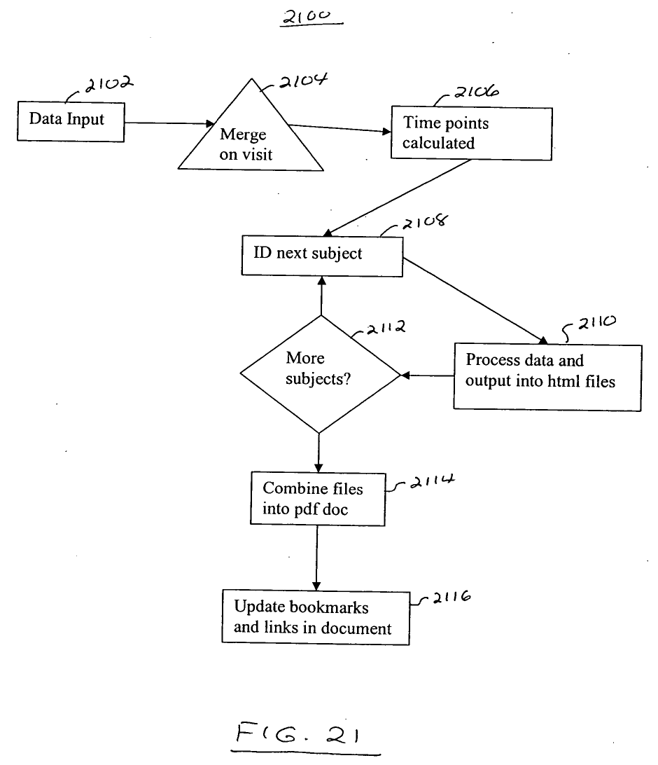

FIG. 21 is a simplified flow chart showing the steps undertaken to create the electronic document package. In a first step 2102 of process flow 2100, data is input to populate the database. In step 2104, shows the merge on visit. Step 2106 shows the calculation of time points. Step 2108 shows the identification of the next subject. Step 2110 shows the processing of data and output into html files. Step 2112 inquires whether data regarding more subjects is to be included in the document. Step 2114 combines different files into the pdf document. In step 2116, bookmarks and links in the electronic document are updated.

This software program is stored as a set of instructions on a computer-readable storage medium. The software program causes a processor of a host computer to access an electronic database storing individual patient information locally, or remotely through a computer network. From this stored patient information, the software program creates the electronic document by comparing the stored data to a predetermined, stored rule set. The resulting electronic document, including any indication of progression of a neurologic disorder, is then displayed by the host computer.

Embodiments of software packages in accordance with the present invention offer the advantage of allowing evaluation of clinical findings over time, thereby providing opportunity for confirmation of suspected progression. For example, abnormalities of gait that persist or worsen over time tend to indicate progression. By contrast, abnormalities of gait that improve or resolve are not scored as progression.

Moreover, embodiments in accordance with the present invention are not useful only to indicate progression of a neurological condition. In a clinical or research setting, an embodiment of the present invention could be utilized to provide a consistent framework to indicate a stabilized neurological state, wherein progression criteria are absent. Such a stabilized condition would evidence the efficacy of a particular treatment regimen, with embodiments in accordance with the present invention providing a consistent basis for illustration and comparison.

By facilitating evaluation of the complete set of findings, the electronic package in accordance with an embodiment of the present invention can ensure that the findings make clinical and anatomic sense, allowing standardized comparison between different subjects.

In addition, embodiments of the electronic document may also include links to the primary medical records forming the basis for an indication of progression. By providing direct access to medication records, clinical laboratory data, radiographic information etc., the software package can aid in determining if the findings are tumor related and not likely explained by other factors.

As described in detail above, embodiments of drug discovery methods in accordance with embodiments of the present invention are particularly suited for implementation in conjunction with a computer. FIG. 8 is a simplified diagram of a computing device for processing information according to an embodiment of the present invention. This diagram is merely an example which should not limit the scope of the claims herein. One of ordinary skill in the art would recognize many other variations, modifications, and alternatives. Embodiments according to the present invention can be implemented in a single application program such as a browser, or can be implemented as multiple programs in a distributed computing environment, such as a workstation, personal computer or a remote terminal in a client server relationship.

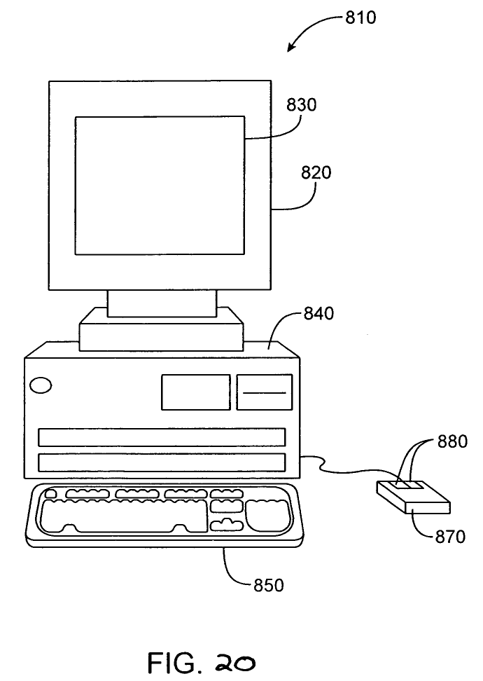

FIG. 20 shows host computer system 810 including display device 820, display screen 830, cabinet 840, keyboard 850, and mouse 870. Mouse 870 and keyboard 850 are representative “user input devices.” Mouse 870 includes buttons 880 for selection of buttons on a graphical user interface device. Other examples of user input devices are a touch screen, light pen, track ball, data glove, microphone, and so forth. FIG. 20 is representative of but one type of system for embodying the present invention. It will be readily apparent to one of ordinary skill in the art that many system types and configurations are suitable for use in conjunction with the present invention. In a preferred embodiment, computer system 810 includes a Pentium™ class based computer, running Windows™ NT operating system by Microsoft Corporation. However, the apparatus is easily adapted to other operating systems and architectures by those of ordinary skill in the art without departing from the scope of the present invention.

As noted, mouse 870 can have one or more buttons such as buttons 880. Cabinet 840 houses familiar computer components such as disk drives, a processor, storage device, etc. Storage devices include, but are not limited to, disk drives, magnetic tape, solid state memory, bubble memory, etc. Cabinet 840 can include additional hardware such as input/output (I/O) interface cards for connecting computer system 810 to external devices external storage, other computers or additional peripherals, further described below.

FIG. 20A is an illustration of basic subsystems in host computer system 810 of FIG. 20. This diagram is merely an illustration and should not limit the scope of the claims herein. One of ordinary skill in the art will recognize other variations, modifications, and alternatives. In certain embodiments, the subsystems are interconnected via a system bus 875. Additional subsystems such as a printer 874, keyboard 878, fixed disk 879, monitor 876, which is coupled to display adapter 882, and others are shown. Peripherals and input/output (I/O) devices, which couple to I/O controller 871, can be connected to the computer system by any number of means known in the art, such as serial port 877. For example, serial port 877 can be used to connect the computer system to a modem 881, which in turn connects to a wide area network such as the Internet, a mouse input device, or a scanner. The interconnection via system bus allows central processor 873 to communicate with each subsystem and to control the execution of instructions from system memory 872 or the fixed disk 879, as well as the exchange of information between subsystems. Other arrangements of subsystems and interconnections are readily achievable by those of ordinary skill in the art. System memory, and the fixed disk are examples of tangible media for storage of computer programs, other types of tangible media include floppy disks, removable hard disks, optical storage media such as CD-ROMS and bar codes, and semiconductor memories such as flash memory, read-only-memories (ROM), and battery backed memory.

While the above is a full description of the specific embodiments, various modifications, alternative constructions and equivalents may be used. For example, the present invention is not limited to analysis of progression of brain tumors, and is also applicable to analysis of the progression of other neurologic conditions, including but not limited to epilepsy. Therefore, the above description and illustrations should not be taken as limiting the scope of the present invention.

What is claimed is:

1. A method of displaying information regarding progression of a neurological disorder, the method comprising:
receiving as an input to a processor,
a first datum of a first type relevant to neurological state of a patient at a first time, and
a second datum of the first type relevant to neurological state of the patient at a second time subsequent to the first time;
causing the processor to apply a rule set to the first datum and the second datum to provide an indication of progression of the neurological disorder; and
causing the processor to generate an electronic document including the indication.

2. The method of claim 1 wherein the indication is displayed in the document by a difference in color between the first datum and the second datum.

3. The method of claim 2 wherein the first and second datum are displayed in the document as a points in a graph having time as an axis.

4. The method of claim 2 wherein the first and second datum are displayed in the document as a table having a row header labeled as the first type.

5. The method of claim 4 wherein the row header is linked to a graph having time as an axis and displaying the first and second datum as points.

6. The method of claim 1 wherein:
the processor further receives,
a first datum of a second type relevant to neurological state of a patient at a third time, and
a second datum of the second type relevant to neurological state of the patient at a fourth time subsequent to the third time;
the first and second datum of the second type are compared to the rule set by the processor to provide an additional indication of progression the neurological disorder; and
the document includes the additional indication.

7. The method of claim 6 wherein the indication is displayed by a difference in color between the first and second data of the first and second types.

8. The method of claim 7 wherein the first and second data of the first type are displayed on a first screen as a points in a first graph having time as an axis, and wherein the first and second data of the second type are displayed on a second screen as points in a second graph also having time as an axis.

9. The method of claim 7 wherein the first and second data of the first type are displayed in a first row of a table having a first row header labeled as the first type, and the first and second data of the second type are displayed in a second row of the table having a second row header labeled as the second type.

10. The method of claim 9 wherein:
the first and second types are related; and
the first and second row headers are linked to a screen displaying a first graph having time as an axis and including the first and second data of the first type as points, and a second graph also having time as an axis and including the first and second data of the second type as points.

11. The method of claim 6 wherein the rule set is configured to distinguish between a major progression criterion and a minor progression criterion.

12. The method of claim 1 wherein the processor is configured to display the indication as a first color change revealing a tentative conclusion of progression, and as a second color revealing a confirmation of progression.

13. An electronic document for visualizing progression of a neurological disorder in an individual patient, the electronic document comprising:
a contents page including a first link to a table of neurological symptoms;
a table of neurological symptoms page including a second link to a graphical display, wherein a progression of the neurological disorder is indicated by a change in color between a first data entry into the table and a second data entry into the table; and
a graphical display page wherein the progression of the neurological disorder is indicated by the change in color between a first data point plotted on a chart and a second data point plotted on the chart.

14. The electronic document of claim 13 wherein the contents page further comprises a third link to a page displaying other than a neurological symptom.

15. The electronic document of claim 13 wherein the graphical display page further comprises a second chart plotting a third data point and a fourth data point.

16. The electronic document of claim 15 wherein the graphical display page further comprises a third link to supplemental graphical display page including one of the first chart and the second chart.

17. The electronic document of claim 13 recorded on a storage medium in a format selected from the group comprising jpg, tiff, giff, html, pdf, doc, rtf, and dhtml.

18. A computer readable storage medium having a computer-readable program embodied therein for directing operation of a host computer including an input/output system, and a processor, wherein the computer-readable program includes instructions for operating the host computer to process medical information according to the following:
receiving a first datum of a first type relevant to neurological state of a patient at a first time;
receiving a second datum of the first type relevant to neurological state of the patient at a second time subsequent to the first time;
applying a rule set to the first datum and the second datum to provide an indication of progression the neurological disorder; and
causing the processor to generate an electronic document including the indication.

19. The computer readable storage medium of claim 18 wherein the computer readable program includes instructions to cause the processor to generate the electronic document comprising a plurality of electronically linked pages including a contents page and a graphics display page.

20. The computer readable storage medium of claim 18 wherein the computer readable program includes instructions to cause the processor to generate the electronic document in a format selected from the group comprising jpg, tiff, giff, html, pdf, doc, rtf, and dhtml.
